(19) United States
(12) Patent Application Publication
(10) Pub. No.: US 2026/0122070 A1
(43) Pub. Date: Apr. 30, 2026

(54) SECURING IDENTITY FOR MULTICLOUD OPERATIONS

(71) Applicant: Oracle International Corporation, Redwood Shores, CA (US)

(72) Inventors: Alexandru Munteanu, Seattle, WA (US); Shobhank Sharma, Bothell, WA (US)

(73) Assignee: Oracle International Corporation, Redwood Shores, CA (US)

(21) Appl. No.: 19/337,550

(22) Filed: Sep. 23, 2025

Related U.S. Application Data
(60) Provisional application No. 63/711,993, filed on Oct. 25, 2024.
(60) Provisional application No. 63/809,762, filed on May 21, 2025.

(51) Int. Cl. H04L 9/40; H04L 9/32

(52) U.S. Cl. CPC H04L 63/10; H04L 9/3247

(57) ABSTRACT

The present disclosure describes solutions to a confused identity security vulnerability that can arise during multicloud operations. In an example method, a second cloud environment receives, from a first cloud environment, a request to perform an operation involving a service manager for a cloud service offered in the second cloud environment. The request can include a first identifier and a URL. The second cloud environment outputs a network request to a network location identified by the URL. The second cloud environment receives a response including a second identifier, which it compares to the first identifier. Upon determining, based upon the comparing, that the second identifier matches the first identifier, the second cloud environment performs processing enable performance of the operation involving the service manager. Upon determining that the second identifier does not match the first identifier, the second cloud environment rejects the request to perform the operation.

### CROSS-REFERENCE TO RELATED APPLICATION

This application claims priority to provisional application U.S. Ser. No. 63/711,993 entitled “AWS-Identity” and filed on Oct. 25, 2024, the entire disclosure of which is incorporated herein by reference for any purpose.

### FIELD

The present disclosure relates generally to security and access management. More specifically, technical solutions are presented for a “confused identity problem” that can arise in various different scenarios. The solution examples described in this disclosure are used to overcome the confused identity problem in a multicloud environment.

### BACKGROUND

Cloud service providers (“CSPs”) can provide a cloud environment and a set of cloud services, such as compute, storage, networking, and databases. This environment can span numerous geographically distributed datacenters, each datacenter housing physical hardware resources that underlie provisioned compute or database instances, storage volumes, and network resources. In a typical scenario, a CSP customer can obtain a subscription to various cloud services with associated access rights, usage limits, and so on. The cloud environment can be configured to provision service instances or resources for the customer in accordance with the subscribed services.

For example, a CSP customer may subscribe to a managed database service. The cloud environment may be configured to provision a database instance, responsive to a suitable command to a service manager for the managed database service. The cloud environment may be further configured with suitable networking resources to enable secure client access to the service manager for the managed database service or the provisioned database instance. In another example, the CSP customer may subscribe to an autonomous database, in which case the database is provisioned using another service manager in a managed execution environment with CSP-managed storage and secure network access controlled via private endpoints in a virtual cloud network (VCN) or network configuration mechanisms.

Some CSPs provide a multicloud environment. In a multicloud environment, multiple CSPs may provide their own cloud environments and sets of cloud services. For example, a first CSP may provide a first cloud environment that the first CSP uses to provide a set of cloud services offered by the first CSP to its customers. A second CSP may provide a second cloud environment that the second CSP uses to provide a different set of cloud services offered by the second CSP to its customers. In certain implementations, the two CSPs may provide functionality that allows a customer of the first CSP, who is also a customer of the second CSP, that subscribes to a cloud service from the set of services provided by the first CSP, to provision or manage resources associated with a cloud service from the set of services provided by the second CSP using a suitable service manager (sometimes referred to as a “control plane”). In this manner, a customer of the first CSP can use or subscribe to a service provided by the second CSP and use that service via the first cloud environment provided by the first CSP by provisioning or managing resources through a service manager or by accessing the provisioned resources.

In some multicloud environments, inter-cloud authentication and authorization may be effected by configuring static credentials in the first cloud environment that are recognized by cloud services in the second cloud environment. For example, a compute instance in the first cloud environment can store an API key or access token for a service manager or control plane for a managed service that is hosted in the second cloud environment that was exchanged over a secure channel prior to use. When the compute instance in the first cloud environment makes a request, the compute instance can include the credential in the request. The service manager or control plane in the second cloud environment can verify the credential against its own authorization system. This scheme is vulnerable to a number of vulnerabilities such as a “man-in-the-middle” attack.

### BRIEF SUMMARY

The present disclosure describes solutions to a “confused identity” or “confused deputy” security vulnerability that can arise during multicloud operations when a customer of a first cloud service provider (CSP) requests an operation to be performed in the second cloud environment provided by a second CSP. For example, during multicloud operations, an unauthorized or malicious caller may direct, from a first cloud environment, a privileged system, such as a service manager for a managed cloud service or a provisioned resource associated with the managed cloud service, in a second cloud environment to carry out operations on behalf of a different caller, causing a potentially severe data breach. The present disclosure describes technical solutions for this problem.

In an example method for securing multicloud operations to mitigate the confused identity problem, a second cloud environment receives from a first cloud environment, a request to perform an operation in the second cloud environment, the request including a first identifier and a URL, in which the first cloud environment is provided by a first CSP and used to provide a first set of cloud services to one or more customers of the first CSP, and in which the second cloud environment is provided by a second CSP different from the first CSP and is used to provide a second set of cloud services to one or more customers of the second CSP. The second cloud environment outputs a network request to a network location identified by the URL. The second cloud environment, responsive to the outputting, receives, from the first cloud environment, a response to the network request including a second identifier. The second cloud environment compares the second identifier to the first identifier. The second cloud environment, upon determining, based upon the comparing, that the second identifier matches the first identifier, performs processing by the second cloud environment to enable performance of the operation. The second cloud environment, upon determining, based upon the comparing, that the second identifier does not match the first identifier, rejects the request to perform the operation in the second cloud environment.

An example non-transitory computer-readable storage medium stores processor-executable instructions configured to cause one or more processors to receive, from a first cloud environment, a request to perform an operation in the second cloud environment, the request including a first identifier and a URL, in which the first cloud environment is provided by a first CSP used to provide a first set of cloud services to one or more customers of the first CSP, and in which the second cloud environment is provided by a second CSP different from the first CSP and is used to provide a second set of cloud services to one or more customers of the second CSP. The processor-executable instructions are further configured to cause the one or more processors to output a network request to a network location identified by the URL. The processor-executable instructions are further configured to, responsive to the outputting, receive, from the first cloud environment, a response to the network request including a second identifier. The processor-executable instructions are further configured to compare the second identifier to the first identifier. The processor-executable instructions are further configured to, upon determining, based upon the comparing, that the second identifier matches the first identifier, perform processing to enable performance of the operation. The processor-executable instructions are further configured to, upon determining, based upon the comparing, that the second identifier does not match the first identifier, reject the request to perform the operation in the second cloud environment.

An example system includes one or more non-transitory computer-readable media and one or more processors communicatively coupled to the one or more non-transitory computer-readable media, the one or more processors configured to execute processor-executable instructions stored in the non-transitory computer-readable media to receive, from a first cloud environment, a request to perform an operation in the second cloud environment, the request including a first identifier and a URL, in which the first cloud environment is provided by a first CSP used to provide a first set of cloud services to one or more customers of the first CSP, and in which the second cloud environment is provided by a second CSP different from the first CSP and is used to provide a second set of cloud services to one or more customers of the second CSP. The system is further configured to cause the one or more processors to output a network request to a network location identified by the URL. The system is further configured to, responsive to the outputting, receive, from the first cloud environment, a response to the network request including a second identifier. The system is further configured to compare the second identifier to the first identifier. The system is further configured to, upon determining, based upon the comparing, that the second identifier matches the first identifier, perform processing to enable performance of the operation. The system is further configured to, upon determining, based upon the comparing, that the second identifier does not match the first identifier, reject the request to perform the operation in the second cloud environment.

### BRIEF DESCRIPTION OF THE DRAWINGS

FIG. 1 shows an example of a system for securing identity for multicloud operations, according to some aspects of the present disclosure.

FIG. 2 shows a flowchart of an example method for securing identity for multicloud operations, according to some aspects of the present disclosure.

FIG. 3 shows a flowchart of an example method for caching and using the cached response from the identifier service for securing identity for multicloud operations, according to some aspects of the present disclosure.

FIG. 4 shows a flowchart of an example method for obtaining and validating additional identifiers for securing identity for multicloud operations, according to some aspects of the present disclosure.

FIGS. 5A-5C show a sequence diagram of an example method for securing identity for multicloud operations, according to some aspects of the present disclosure.

FIG. 6 is a high level diagram of a distributed environment showing a virtual or overlay cloud network hosted by a cloud service provider infrastructure according to certain embodiments.

FIG. 7 depicts a simplified architectural diagram of the physical components in the physical network within CSPI according to certain embodiments.

FIG. 8 shows an example arrangement within CSPI where a host machine is connected to multiple network virtualization devices (NVDs) according to certain embodiments.

FIG. 9 depicts connectivity between a host machine and an NVD for providing I/O virtualization for supporting multitenancy according to certain embodiments.

FIG. 10 depicts a simplified block diagram of a physical network provided by a CSPI according to certain embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

FIG. 16 depicts a simplified high-level diagram of a distributed environment comprising multiple cloud environments provided by different cloud service providers wherein the cloud environments include a particular cloud environment that provides specialized infrastructure that enables one or more cloud services provided by that particular cloud environment to be used by customers of other cloud environments according to certain embodiments.

FIGS. 17A and 17B depict exemplary flow diagrams for linking two user accounts in different cloud environments, according to some embodiments.

FIG. 18 depicts an exemplary system diagram illustrating components of a multi-cloud control plane according to some embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure describes solutions to a “confused identity” or “confused deputy” security vulnerability that can arise during multicloud operations when a customer of a first CSP requests an operation to be performed in the second cloud environment provided by a second CSP. In such a scenario, the identity management system of the second cloud environment may get “confused” as to the identity of the user. For example, during multicloud operations, an unauthorized or malicious caller may direct, from a first cloud environment, a privileged system (e.g., a service manager or control plane) or resource (e.g., database instance) in a second cloud environment to carry out operations on behalf of a different caller, causing a potentially severe data breach. The present disclosure describes technical solutions for this problem.

To illustrate the confused identity problem, consider a first CSP, a second CSP, and an entity that is a customer of both the first CSP and the second CSP. The customer may subscribe to services hosted in a first cloud environment provided by the first CSP and to services in a second cloud environment provided by a second CSP. While the customer may use services in the first cloud environment for certain purposes, it may be desirable to use services on the second cloud environment provided by the second CSP from time to time. For example, the second CSP may offer a particular managed database service that is not supported by the first CSP. In this case, for example, the customer can configure applications executing on compute instances in the first cloud environment provided by the first CSP to execute management operations relating to the managed database service in the second cloud environment provided by the second CSP. For example, a service manager or control plane associated with the managed database service in the second cloud environment can be used for operations such as provisioning database instances, monitoring or managing provisioned database instance configurations, and so on.

To do this, the application executing in a compute instance in the first cloud environment (hereinafter the “caller”) may output a request to the second cloud environment, a request (e.g., a REST API request or a remote query over a TCP/IP connection) to perform an operation in the second cloud environment. For example, the operation may be a management operation to be performed by the service manager for the managed database service in the second cloud environment provided by the second CSP, such as an instruction to provision a new database instance or resource. This example involves an application making a programmatic request, but the technique applies equally to any suitable application, daemon, delegate, role, administrator, or user that is associated with the customer. For example, the caller can use a programmatic or web-based API, command line interface (“CLI”), or other interface to cause the request to perform the operation in the second cloud environment to be output. In some examples, the application may be a proxy interface provided by the first CSP for the service manager in the second cloud environment.

The “confused identity” problem arises here because the second cloud environment has not independently authenticated the caller. In other words, the second cloud environment receives the request with instructions to perform a privileged action (e.g., query the database instance) but has no proof that the requesting entity (in this case, the application), is who it claims to be.

Existing systems may rely on schemes such as federated identity (also referred to as token-passing schemes) to provide authentication in this scenario. Federated identity may involve the first cloud environment issuing a signed authentication token (such as a JSON Web Token (JWT) or Security Assertion Markup Language (SAML) assertion) asserting the caller's identity. The second cloud environment can then receive the token and validate it by, for example, verifying a cryptographic signature of the token using the first CSP's public key or that the token has not expired.

Such a scenario is vulnerable to a “man in the middle” (MitM) attack, in which a malicious user could impersonate the caller, directing the service manager or control plane in the second cloud environment to execute management operations that the customer has not authorized, leading to potentially very serious compromises of resources in the second cloud environment. For example, the federated identity scenario is vulnerable to a MitM attack if the second cloud environment fails to properly validate the token's cryptographic signature or freshness, or if the first CSP's key management is compromised.

Some existing systems may instead use API keys or static credentials embedded in application code, configuration files, or environment variables particular to each customer to authenticate multicloud requests. For example, the first cloud environment could include a password or API key along with the request that can be verified for an exact match or against a hash of the credential by the second cloud environment. However, such credentials are again vulnerable to MitM attacks and can be intercepted and then reused by unauthorized parties to impersonate the customer making requests from the first cloud environment.

In both examples of how existing systems behave, significant risk of unauthorized access or privilege escalation with respect to the service manager or control plane in the second cloud environment may exist. Such unauthorized access could allow malicious actors to perform management operations that disrupt availability, exfiltrate sensitive data, or alter system configurations. In addition, privilege escalation within the control plane could compromise isolation guarantees, enabling attackers to affect multiple tenants or services beyond their original scope.

In some examples, the “confused identity” problem (alternatively referred to as the “confused deputy” problem) can be addressed using the systems and methods for securing identity for multicloud operations according to this disclosure. In one example method for addressing the confused identity problem, a request from a caller to perform an operation involving a managed service in a second cloud environment operated by a second CSP is first received in a first cloud environment operated by a first CSP by a second control plane in the second cloud environment. In this context, a “control plane” can refer generally to a management component or service in the second cloud environment that provides APIs for provisioning resources, authorizing access to resources, and other resource coordination operations. In this example, the requested operation may be a management operation for a control plane for a cloud service offered in the second cloud environment such as creating a new virtual machine, scaling a container cluster, provisioning a database instance, configuring a load balancer, initiating a backup and restore process, and so on.

The request may be sent on behalf of a customer of both the first and second CSPs. The request may include a first identifier (e.g., an alphanumeric account or customer id string) and a uniform resource locator (URL) that identifies an API endpoint in the first cloud environment. The URL may be cryptographically signed using a private key held by the first CSP. Consequently, the authenticity of the URL may be verified by the second cloud environment using the public key of the first CSP. After verifying the authenticity of the URL, the second control plane in the second cloud environment can then output an API request (e.g., an HTTP GET request) to the URL and receive in response a second identifier, such as another alphanumeric string. The second control plane can compare the first identifier with the second identifier and process or reject the request to perform the operation based on the comparison.

This example method solves the confused identity problem because it requires the second CSP to verify the requestor's identity by issuing a callback to an endpoint under the control of the first CSP, using a URL that only the first CSP can sign, as confirmed using the digital signature. This approach is not susceptible to MitM attacks described above because there is no token to intercept. Instead, the requestor's identity is immediately identified using a trusted source identified by the first cloud environment (i.e., the location identified by the pre-signed URL). Additionally, the disclosed techniques enforce timely authentication, since every privileged operation requires a verification using information obtained from a trusted location (or recently cached information). Additionally, because the techniques eliminate the need for long-lived, broadly scoped credentials reducing the potential “blast radius” of any misconfiguration or compromise. The disclosed techniques thus constitute a significant improvement to the technical field of security and access management in the multicloud context.

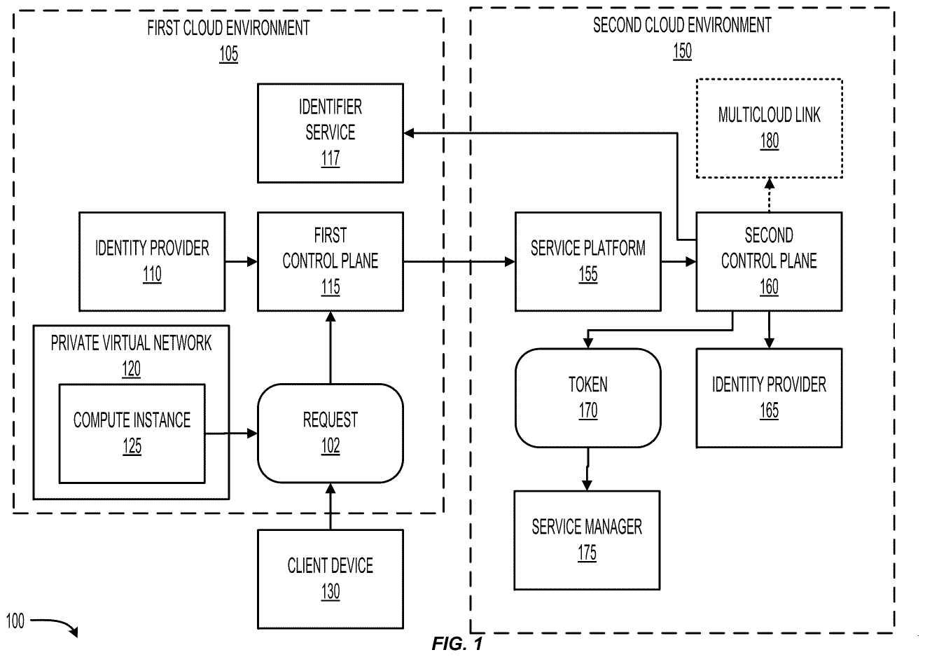

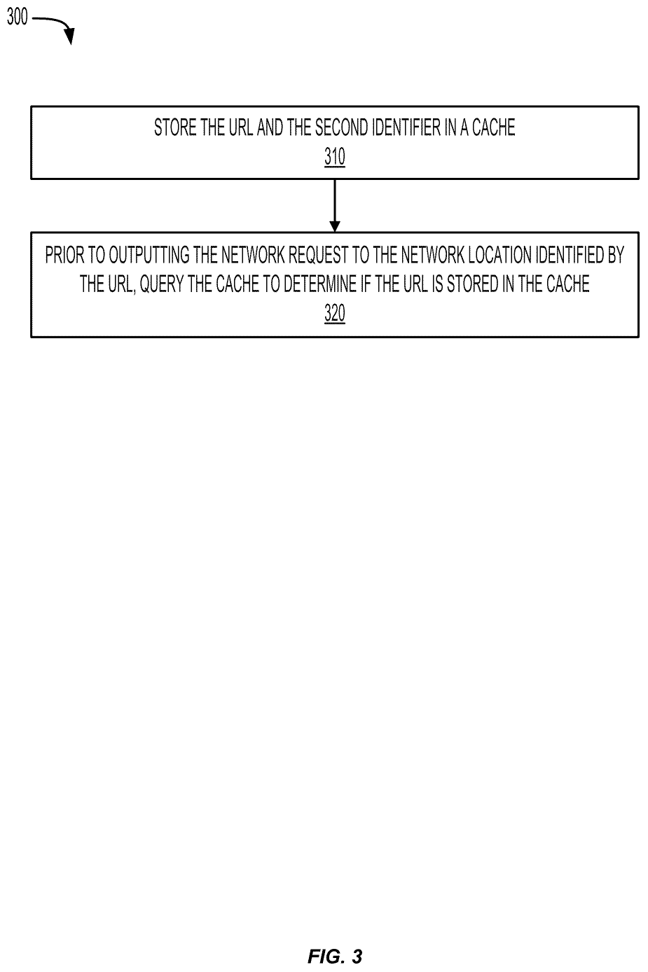

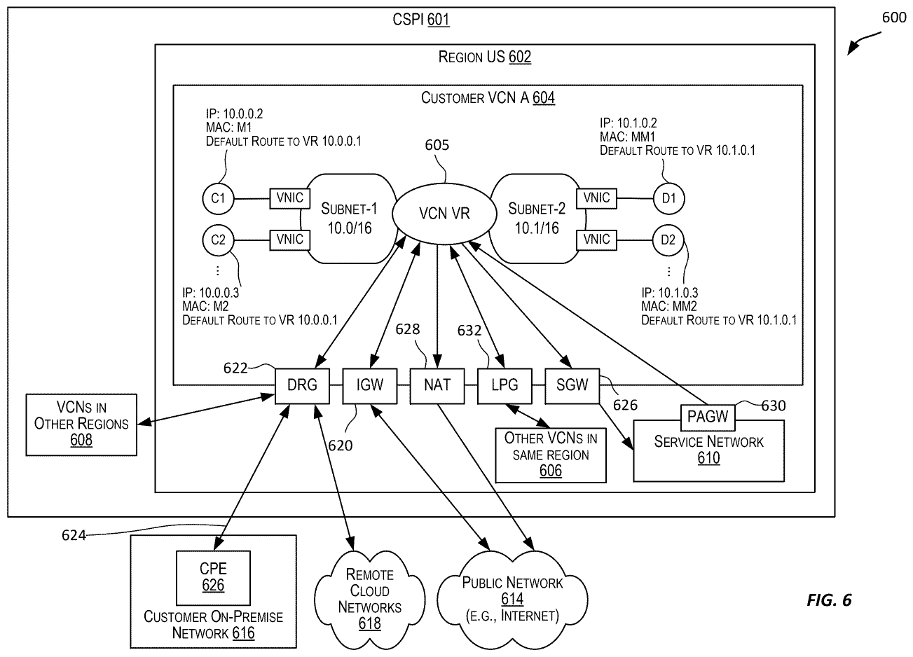

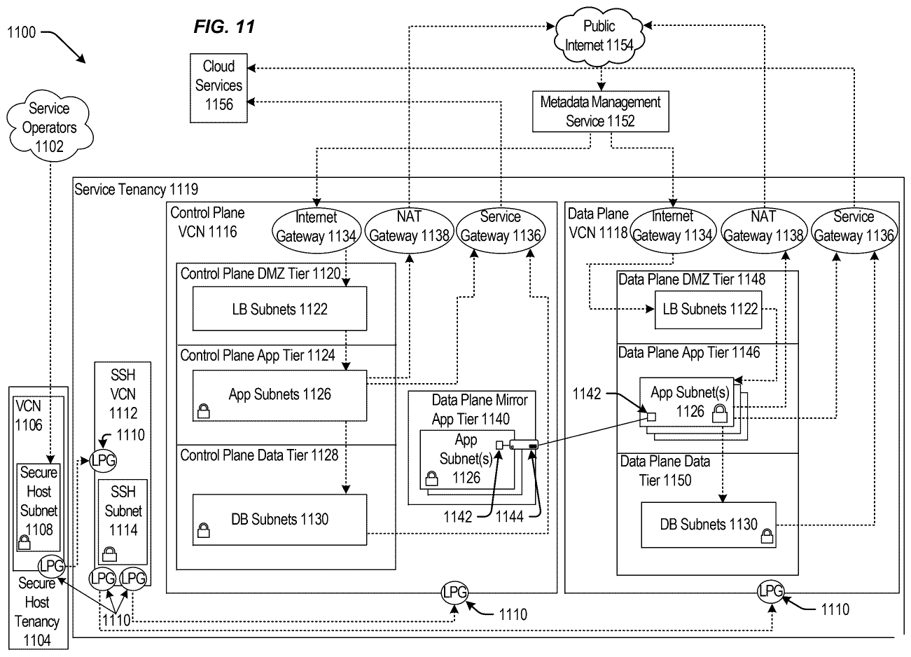

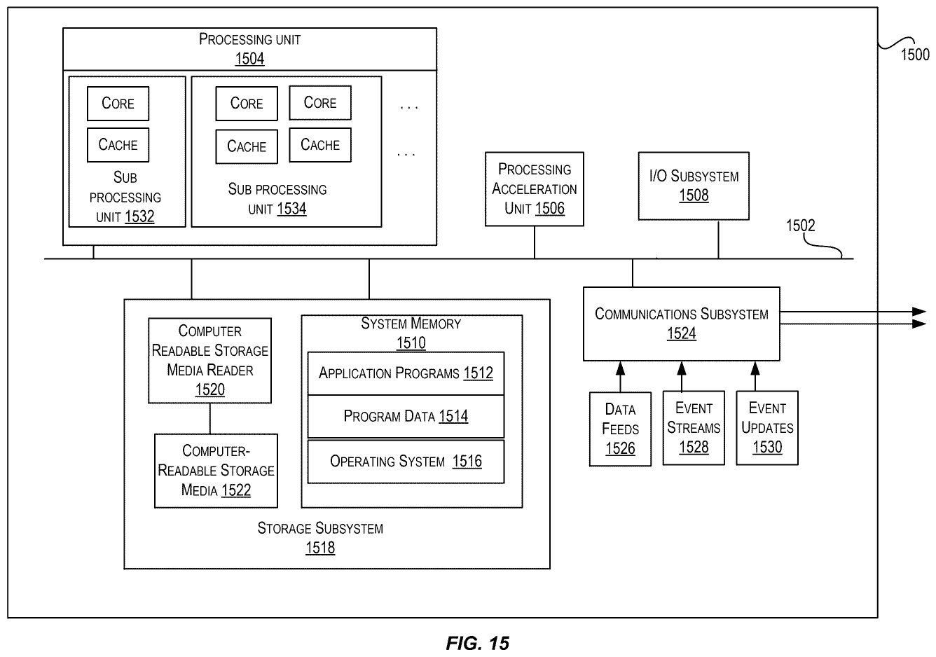

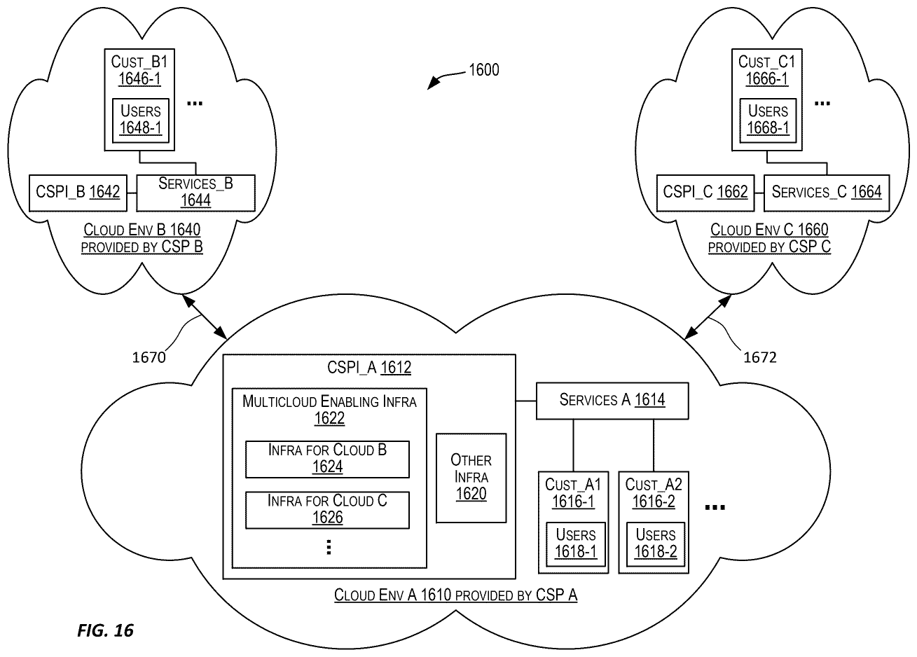

The systems and methods for securing identity for multicloud operations will now be described with reference to several figures. FIG. 1 shows an example of systems for securing identity for multicloud operations. FIGS. 3-6 show examples of methods for securing identity for multicloud operations. FIGS. 6-10 and the associated description provided in the “Example Virtual Networking Architecture” section below describe networking concepts including network virtualization, substrate networks, overlay networks, VNICs, etc., and provide examples of environments in which certain embodiments described in this disclosure may be implemented. FIGS. 11-14 depict examples of architectures for implementing cloud infrastructures for providing one or more cloud services, where the infrastructures may incorporate teachings described herein. FIG. 15 depicts a block diagram illustrating an example computer system or device, according to at least one embodiment. FIGS. 16-18 illustrate examples of multicloud architectures that accord with certain examples described herein.

Turning now to FIG. 1, FIG. 1 shows an example of a system 100 for securing identity for multicloud operations, according to some aspects of the present disclosure. System 100 includes a first cloud environment 105 and a second cloud environment 150, operated by a first CSP and a second CSP respectively. Both cloud environments 105 and 150 are enclosed in dashed lines to schematically indicate their respective cloud service provider infrastructures (CSPIs), including physical hosts, virtualized compute instances, storage volumes, and network fabric provisioned by the CSP. Each cloud environment 105, 150 may include resources such as virtual cloud networks, block volumes, and load balancers, as well as cloud service instances, such as compute instances (e.g., virtual machines or bare metal servers), database instances, or container engine nodes, provisioned and managed within the respective CSP infrastructure.

In certain examples, a customer of both the first CSP and the second CSP may desire to access the service manager 175 for a managed cloud service in the second cloud environment 150. For example, the customer may initiate the request 102 from client device 130 used by the customer (e.g., a user, administrator, or service account associated with the first CSP customer), which may be a laptop, desktop, smartphone, tablet, or the like. The client device 130 may execute client software such as client software suitable for accessing the service manager 175 (e.g., a management client for controlling or configuring management operations associated with a cloud database service). The client device 130 may also initiate the request 102 in response to a command received from an interface such as a command-line interface (CLI) tool, program code executing on the client device 130, or web application/console provided by the first CSP, among other sources of the request 102. In some examples, the request 102 may be initiated by a compute instance 125 provisioned in a private virtual network 120 such as a virtual cloud network (VCN). The compute instance 125 may be configured to execute an application, container, or other program code that causes the request 102 to be generated and output to the second cloud environment 150 on behalf of the customer.

The request originator, whether the compute instance 125, the client device 130, or other computing system, can be configured to route the request 102 to the first control plane 115 of the first cloud environment 105. The first control plane 115 may be, for example, a service provided by the first CSP to facilitate multicloud interactions between the first cloud environment and the second cloud environment. The first control plane 115 can create a pre-signed URL using information about the customer obtained from the identity provider 110 and add it to the request 102. For example, the request 102 may be created as an HTTP POST message by the client device 130, including a number of HTTP headers. The first control plane 115 can add the pre-signed URL to the request 102 as an additional HTTP header. For example, the pre-signed URL may be added as a header with key “X-CSP1-PreSigned-Url” and value the URL. In some examples, the first control plane 115 may add additional information (e.g., as additional headers) such as the first CSP's customer account identifier, the second CSP's customer account identifier, identifiers of the sending resource or target service manager, and so on.

In some cases, additional portions of the request 102 may be signed in addition to the pre-signed URL such as the additional headers to further mitigate MitM attacks. For example, a text containing the additional headers or all headers preceded with the “X” prefix in a standardized format may be signed using a private key controlled by the first CSP. The digital signature may be included as another header, in the body of the HTTP request 102, or as a query parameter. The digital signature can be verified using the public key of the first CSP.

The first control plane 115 forwards the request 102 to the second cloud environment 150 for processing by the second control plane 160 of the second cloud environment 150. In some examples, the route to the second control plane 160 may include a service platform 155. The service platform 155 may be middleware or API gateway that enables centralized control for services of functionality such as authentication, authorization, tag validation, auditing, quota/limit enforcement, and so on. Certain services (e.g., the second control plane 160) can be associated with the service platform 155 by way of a service platform service registry (not shown) that maintains a record of second control plane 160 API specifications and other configuration data. For services associated with the service platform 155, when a client outputs a request 102 to access a service such as a second control plane 160, the service platform 155 can intercept the request 102 and act as an API gateway for the second control plane 160, receiving and forwarding the request 102 to the second control plane 160. In this example, the service platform 155 may forward the request 102 “as is” or may map the request 102 to a standardized request format that is compatible with the API of the second control plane 160.

The second control plane 160 can be configured to mediate inbound multicloud management operations from the first cloud environment 105 to the second cloud environment 150. For example, the second control plane 160 can provide an API that can receive requests from the first control plane 115, verify the customer's identity using the techniques of this disclosure, and then use the verified identity information to authenticate and authorize the request 102 using the identity provider 165 of the second cloud environment and other resources in the second cloud environment 150. The second control plane 160 can also be configured to issue tokens or other credentials as needed for downstream service calls, or to interface with the identity provider 165 to obtain or forward tokens or other credentials.

The second control plane 160 can receive the request 102 to perform an operation involving the service manager 175 such as a database service management operation. As mentioned previously, the request 102 may include an identifier (e.g., an account identifier) and a pre-signed URL. The second control plane 160 can verify the validity of the digital signature included with the request 102. For example, the digital signature may be included as a query parameter in the request (e.g., “http://sts.first-csp.com/?signature=abcde12345”). In this example, the digital signature is the hexadecimal string “abcde12345”. The digital signature can be verified using the public key of the first CSP that corresponds to the private key used to generate the digital signature. If the digital signature cannot be verified, the request 102 can be ignored. In some examples, failed verifications may be logged or cause notifications to network or security engineers.

The second control plane 160 can output a network request (e.g., an HTTP request) to the network location identified by the URL, such as the identifier service 117. The identifier service 117 may be configured to, upon receiving the HTTP request from the second control plane 160, return identity information of the requesting customer, as well as other information. The response may include, for example, an account identifier associated with a customer of the first CSP or identifying information for the component that caused the pre-signed URL to be generated (e.g., the calling client device or application). In some examples, the identifier service 117 may be a security token service (STS) operated by the first CSP. In this example, the identifier service 117 can provide an endpoint associated with the pre-signed URL which returns the identity details, such as first CSP account identifier information or caller identifier information, of the caller.

To further improve security, the second control plane 160 can be configured with a “whitelist” or “allow list” that includes hosts or domains that may be included in URL. In this case, the second control plane 160 will only output the network request to the network location identified by the URL if the host or domain included in the URL is explicitly allowed. Otherwise, the second control plane 160 rejects the request to perform the operation in the second cloud environment. For example, the request 102 may be dropped or discarded or a response may be sent along with a suitable error message (e.g., an HTTP response with a 403 “Forbidden” status code).

The second control plane 160 can then independently confirm the authenticity and origin of the request 102 by matching the returned identity information against the initial identifier included with the request 102. This verifies the identity of the customer originating the request 102 to secure the multicloud operation against MitM attacks and other vulnerabilities. In some examples, the authorizations associated with the customer may also be verified. For example, the request 102 may include a header with key such as “X-CSP1-Caller-Account-Url” and value “a1b2d3”. The call to the pre-signed URL may return a JSON object including a field with key “Account” and value “a1b2d3”. In this example, the second control plane 160 can verify that the “X-CSP1-Caller-Account-Url” value matches the “Account” value. Upon determining that the identifiers match, the second control plane 160 can enable performance of the operation involving the service manager 175. On the other hand, upon determining that identifiers do not match, the second control plane 160 can reject the request to perform the operation in the second cloud environment involving the service manager 175. In some examples, a failed match may be logged or cause notifications to network or security engineers to cause a security response.

To enable performance of the downstream operation, the second control plane 160 can issue a security token 170 such as a Resource Principal Session Token (RPST). The RPST can encapsulate the authenticated caller's identity and may be accepted by the resource 175 as proof of the same. In some cases, the authenticated caller's authorizations may be similarly encapsulated, as well as other data. For example, if the service manager 175 is a control plan for a managed database service offered by the second CSP, the database instance can accept the RPST as a secure assertion of the caller's identity and/or entitlements. Further, the RPST can be used to limit the allowed management operations to only those that are authorized by the policies encoded in the token. For instance, the RPST may include structured data fields representing the caller's verified identity, mapped entities in the second cloud environment, explicit authorizations, etc. within a cryptographically signed payload that can be verified by the service manager 175 prior to executing the requested operations.

In some examples, the second cloud environment 150 includes a multicloud link 180. The multicloud link 180 may be configured to store and maintain information relating the first CSP to the second CSP. For example, the multicloud link 180 may maintain mappings between accounts associated with the first CSP (and any authorized shared accounts) and the corresponding accounts associated with the second CSP. For instance, an account associated with the first CSP (the “buyer” account) may be linked to a corresponding account in the second CSP when multicloud operations are configured. During this configuration, the buyer account may identify one or more shared accounts that should likewise be mapped to the target account in the second CSP. This mapping can be used to determine which accounts from the first CSP may be authorized to perform operations in the second cloud environment. To this end, the multicloud link 180 may provide an API that can return a “cloud link object.” The cloud link object may be a data structure maintained by the multicloud link 180 that includes a mapping between an account associated with the first CSP (and any authorized shared accounts) and the corresponding account associated with the second CSP. The cloud link object can be used to support authentication, authorization, policy enforcement, etc. for multicloud operations. The cloud link object may include, for example, the buyer account identifier, a collection of shared account identifiers, and a cloud link identifier. The presence of the cloud link identifier can indicate that multicloud operations for the buyer account (and any authorized shared accounts) have been authorized and configured. For example, the second control plane 160 can be configured to only issue the security token 170 when authorization is indicated by the cloud link object.

In some cases, such as when multicloud operations are being configured (also referred to as “procurement”), a cloud link identifier or cloud may not be available, but certain limited multicloud operations may still be allowed. For example, during procurement, the first cloud environment may request certificate information associated with the second CSP to set up multicloud operations. This may involve a request to, for example, a certification service in the second cloud environment 150. In such cases, the caller account identifier can be matched against the authorization information returned from the identifier service 117 following invocation of the pre-signed URL. The request to the certificate service can then proceed without first obtaining the cloud link object from the multicloud link 180. Because it may not be used during all multicloud operations, the multicloud link 180 is shown in FIG. 1 using a dotted line.

The examples described in system 100 involve operations such as management operations directed to the service manager 175, which may be the control plane for a cloud managed service. However, the techniques of the present disclosure may also be applicable to provisioned resources or instances, which may be similarly vulnerable to MitM attacks as described above. For instance, an attacker successfully exploiting the confused identity vulnerability for requests to operate a database instance (e.g., query the database) could potentially exfiltrate sensitive data from the database in the second cloud environment, delete or corrupt records, escalate privileges to gain broader access within the second cloud environment, or provision additional resources for malicious purposes. These events could lead to data breaches, service outages, financial loss, or regulatory violations. A similar process to the techniques described herein can be used to improve the security of such data plane transactions.

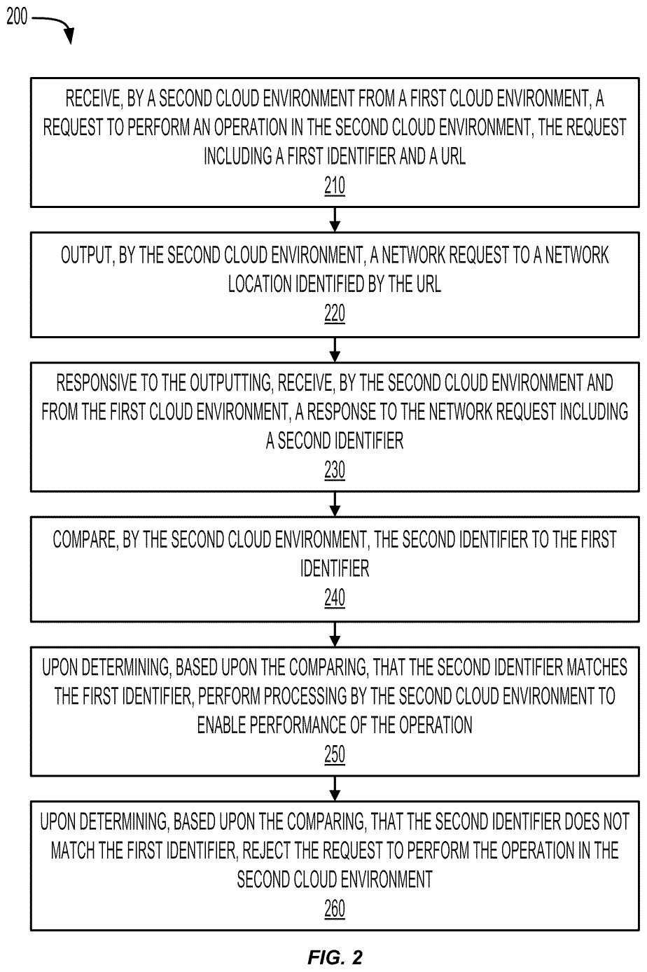

Referring now to FIG. 2, FIG. 2 shows a flowchart of an example method 200 for securing identity for multicloud operations, according to some aspects of the present disclosure. The description of the method 200 in FIG. 2 will be made with reference to FIG. 1, however any suitable system according to this disclosure may be used. It should be appreciated that method 200 provides a particular method for securing identity for multicloud operations. Other sequences of operations may also be performed according to alternative examples. For example, alternative examples of the present disclosure may perform the steps outlined below in a different order. Moreover, the individual operations illustrated by method 200 may include multiple sub-operations that may be performed in various sequences as appropriate to the individual operation. Furthermore, additional operations may be added or removed depending on the particular applications. Further, the operations described in method 200 may be performed by different devices. For example, the description is given from the perspective of a cloud environment (e.g., second cloud environment 150 of FIG. 1) but other configurations are possible. One of ordinary skill in the art would recognize many variations, modifications, and alternatives.

The method 200 may include block 210. At block 210, a computing system, such as the second control plane 160 of the second cloud environment 150 in FIG. 1, receives a request to perform an operation in the second cloud environment, the request including a first identifier and a URL. The request may be received from the first control plane 115 of the first cloud environment 105. The request may be created in response to an action taken by a customer of the first CSP (e.g., a CLI or console action), or customer application executing in a compute instance in the first cloud environment 105. The user or application creating the request (the “caller”) can have an associated customer account. For example, the first CSP may enable customers to establish numerous accounts for users, applications, services, etc. Multicloud operations can be enabled for one or more such accounts, which can be explicitly configured when multicloud operations are configured or procured.

The operation may be a performance by a service manager or control plane for a cloud service offered by the second cloud environment 150. The cloud service may be a managed database service, a managed storage service, a container orchestration service, a machine learning service, or any other managed service that is managed from within the second cloud environment 150. For example, a user associated with a customer account of may cause a management operation such as a new database instance provisioning request by a managed database service in the second cloud environment 150 to be routed to the second cloud environment 150.

The request may be intercepted by the first control plane 115. The first control plane 115 can use information obtained from the identity provider to add additional information to the request (e.g., HTTP headers) that can be used to overcome the confused deputy problem that can otherwise result. The added information may include the account identifier of the caller and a pre-signed URL. In some examples, the added information may further include additional account identifiers such as the buyer account identifier. In this context, the buyer account identifier can refer to the first CSP customer account used to configure multicloud operations. The buyer account may be distinct from the caller account, which may be one of several additional or “shared” accounts identified by the customer as authorized for certain multicloud operations during configuration. For instance, the request may include a number of HTTP headers with keys such as “X-CSP1-Caller-Account-Id”, “X-CSP1-Buyer-Account-Id”, or “X-CSP1-PreSigned-Url”. These fields may have values that are the caller account identifier, the buyer account identifier, and the pre-signed URL, and a resource anchor identifier, respectively.

In some examples, the added information may further include resource identifiers as indicated by the header key “X-CSP1-resource-anchor-id”. In this context, resource identifiers may refer to another form of identifier used by the first CSP such as a “resource anchor.” A resource anchor may, for example, uniquely identify a cloud resource within a cloud environment (e.g., a unique user identifier string). A resource anchor may include, for example, a partition identifier, a service provided by the first CSP, a region, an account identifier, and resource identifier, concatenated together. In some examples, the resource anchor may be used to link cloud resources or services when they are provisioned or configured. For example, a service manager or resource in the second cloud environment may be labeled with a resource anchor. The designated resource anchor can then be used when operating or configuring the respective service manager or resource from the first cloud environment.

The request may then be output by the first control plane 115 for the first cloud environment 105 and received by the second control plane 160 for the second cloud environment 150 that is configured to authorize access to the service manager or control plane by the compute instance. In some examples, the request may be first be intercepted and then forwarded by an API proxy or service platform such as service platform 155. The service platform 155 can, for example, adapt the request from the first control plane 115 to a format used or expected by the API of the second control plane 160 since the first CSP and second CSP may have differing organizational standards for request format.

At block 220, the computing system outputs, by the second cloud environment, a network request to a network location identified by the URL. For example, the URL may be a pre-signed URL that includes a digital signature as a query parameter. After verifying the validity of the digital signature, the computing system can output an HTTP (or other suitable protocol) request to the network location specified by the URL. The URL may be a hostname and path, which must first be resolved to an IP address using a domain name system or the like. In some examples, the URL is an IP address. The URL may include one or more query parameters, in addition to the digital signature, that can be used to identify the caller or a component or account of the second cloud environment 150. The network location specified by the URL may be, for example, a security token service or an identifier service such as identifier service 117 of FIG. 1. The identifier service may be configured to, upon receiving the HTTP request from the second control plane 160, return identity information of the requesting customer and account, as well as other information.

In some examples, the request may include additional identifiers, such as a “buyer” account identifier (e.g., the customer account used to procure or configure multicloud operations), the caller account identifier, shared account identifiers, and so on, in addition to the first identifier and the URL. This information added to the request by the first control plane may itself be cryptographically signed using a private key of the first CSP. This cryptographic signature can be verified using a public key of the first CSP that corresponds to the private key of the first CSP. This digital signature adds an additional layer of security, in addition to the signature associated with the pre-signed URL, that can further reduce the likelihood of a MitM or reply attack that exploits the confused deputy problem.

At block 230, the computing system, responsive to the outputting, receives, by the second cloud environment and from the first cloud environment, a response to the network request including a second identifier. The response may include, for example, an account identifier associated with a customer of the first CSP or identifying information for the component that caused the pre-signed URL to be generated (e.g., the “calling” client device or application). For instance, the response may be a JSON object including fields such as “UserId”, “Account”, and “Arn”. In this example, the “Account” field corresponds to the customer account of the caller; the “UserId” field corresponds to the user identifier of the caller (e.g., a user with associated with an account who is requesting the operation from a CLI or console); and the “Arn” field may correspond to a resource number or identifier that uniquely identifies the user and/or account among the entities tracked or maintained by the first CSP.

At block 240, the computing system compares, by the second cloud environment, the second identifier to the first identifier. In some examples, access to the service manager or control plane in the second cloud environment is allowed only if the first and second identifiers match exactly. For instance, the first identifier and the second identifier in the authorization information may be alphanumeric string account numbers that must match exactly (e.g., “12345ABCDE”). For example, the computing system can compare the value of the “X-CSP1-Caller-Account-Id” header to the value of the “Account” field of the response. In some examples, the “Account” field may be compared to the “X-CSP1-Buyer-Account-Id” additionally or alternatively.

At block 250, the computing system upon determining, based upon the comparing, that the second identifier matches the first identifier, performs processing by the second cloud environment to enable performance of the operation. For example, the second control plan can generate or obtain a security token (e.g., an RPST) that can be forwarded to the downstream service manager or control plane as bearer's proof of successful authentication as well as, in some example, an assertion of authorized operations.

At block 260, the computing system, upon determining, based upon the comparing, that the second identifier does not match the first identifier, rejects the request to perform the operation in the second cloud environment. This may occur as a result of a misconfiguration, expired token, or other benign reason. In some examples, however, the non-matching may be a result of a MitM or reply attack, in which case the mechanism disclosed herein for successfully preventing such an attack will have effectively done so. Upon rejecting the request, the computing system may return a suitable error message indicating that the attempted operation has been rejected due to a failed authentication attempt (e.g., an HTTP error message with status code 403). In some examples, failed authentications may be logged or cause notifications, alerts, or alarms to network or security engineers.

Referring now to FIG. 3, FIG. 3 shows a flowchart of an example method 300 for caching and using the cached response from the identifier service for securing identity for multicloud operations, according to some aspects of the present disclosure. The description of the method 300 in FIG. 3 will be made with reference to FIG. 1, however any suitable system according to this disclosure may be used. It should be appreciated that method 300 provides a particular method for securing identity for multicloud operations. Other sequences of operations may also be performed according to alternative examples. For example, alternative examples of the present disclosure may perform the steps outlined below in a different order. Moreover, the individual operations illustrated by method 300 may include multiple sub-operations that may be performed in various sequences as appropriate to the individual operation. Furthermore, additional operations may be added or removed depending on the particular applications. Further, the operations described in method 300 may be performed by different devices. For example, the description is given from the perspective of a cloud environment (e.g., second cloud environment 150 of FIG. 1) but other configurations are possible. One of ordinary skill in the art would recognize many variations, modifications, and alternatives.

As described in block 230 above, the computing system can receive a response to the network request to the pre-signed URL that may include an account identifier such as an account identifier associated with a customer of the first CSP or identifying information for the component that caused the pre-signed URL to be generated (e.g., the “calling” client device or application). The response from the identifier service 117 may have an associated expiration time to contain the scope of a compromise in the event the response is obtained by an attacker. However, in some cases, repeated requests to the service manager or control plane for the cloud service in the second cloud environment may be made by the caller in a short period of time. In this case, the second cloud environment can be configured to briefly cache the response (e.g., for the duration of the expiration time) to improve efficiency and reduce network bandwidth consumption.

To this end, the method 300 may include block 310. At block 310, a computing system, such as the second control plane 160 of the second cloud environment 150 in FIG. 1, stores the URL and the second identifier in a cache. For example, the cache may be an in-memory key-value store (e.g., Redis or memcached), a filesystem, a data structure in volatile memory, and so on. The URL can be used as the key and the second identifier (and other information returned in the response to invoking the URL) can be the value. The entry associated with the URL key can be configured to expire at the same time the URL itself expires. In some examples, the expiration time may be configured to expire at an earlier time than the expiration time of the URL to account for the time delay between expiration and obtaining a new pre-signed URL.

At block 320, the computing system, prior to outputting the network request to the network location identified by the URL, queries the cache to determine if the URL is stored in the cache. For example, the in-memory key-value store can be queried using the URL as the key. The response may be stored as the value as-is, which can be used as a “drop-in” replacement for the response. If the entry associated with the URL has expired, the computing system can be configured to default to outputting the network request to the network location identified by the URL. The new response can then be cached a described in block 310.

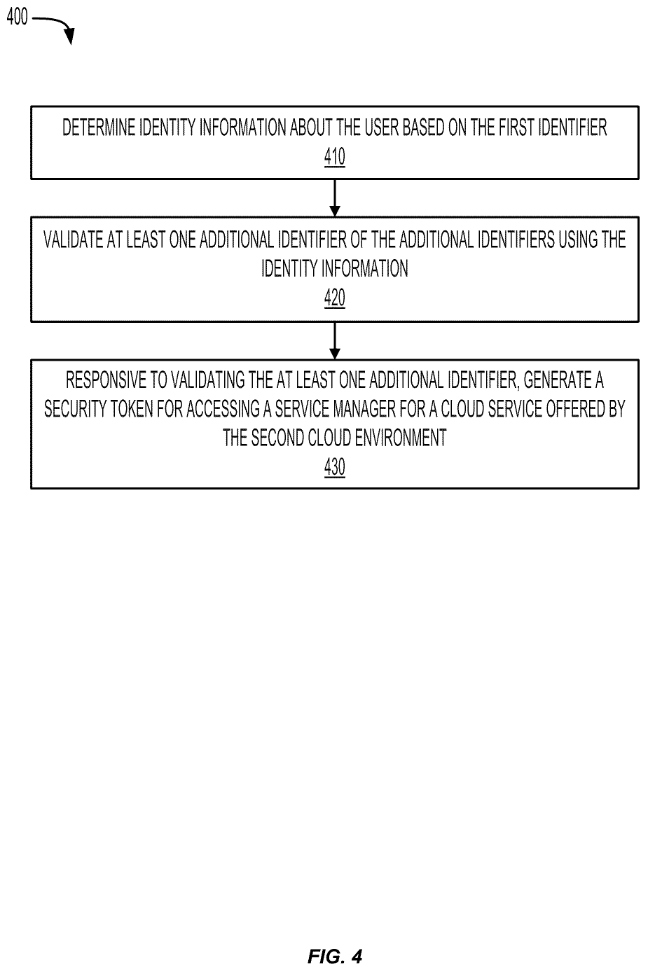

Referring now to FIG. 4, FIG. 4 shows a flowchart of an example method 400 for obtaining and validating additional identifiers for securing identity for multicloud operations, according to some aspects of the present disclosure. The description of the method 400 in FIG. 4 will be made with reference to FIG. 1, however any suitable system according to this disclosure may be used. It should be appreciated that method 400 provides a particular method for securing identity for multicloud operations. Other sequences of operations may also be performed according to alternative examples. For example, alternative examples of the present disclosure may perform the steps outlined below in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices. For example, the description is given from the perspective of a cloud environment (e.g., second cloud environment 150 of FIG. 1) but other configurations are possible. One of ordinary skill in the art would recognize many variations, modifications, and alternatives.

In some examples, the request may include additional identifiers of the customer account (e.g., user, service, application, etc.) associated with the first cloud environment and the second cloud environment. The additional identifiers can be used for additional validations in addition to the caller account matching described in block 240 above. To this end, the method 400 may include block 410. At block 410, a computing system, such as the second control plane 160 of the second cloud environment 150 in FIG. 1, determines identity information about the user based on the first identifier. For example, the additional identity information may be linkage information for a first customer associated with both the first cloud environment and the second cloud environment. Such linkage information may take the form of a cloud link object obtained from a component such as the multicloud link 180 of FIG. 1. The cloud link object may include additional identity information that maps first CSP customer accounts to second CSP customer accounts for multicloud operations. For instance, the additional identity information may be included in a JSON object returned from the multicloud link 180 following a query on the buyer account identifier included in the request. The JSON object may include fields such as “id” that identify the second CSP customer account mapped the first CSP customer account; “buyerCSP1AccountId” that indicates the buyer first CSP customer account used to configure or procure multicloud operations; and/or “sharedCSP1AccountIds” that indicate the shared first CSP customer accounts configured for multicloud operations (e.g., an array or other collection of account identifiers).

At block 420, the computing system validates at least one additional identifier of the additional identifiers using the identity information. For example, the computing system can verify that the buyer and/or caller account identifier included in the request (and returned by the queried URL) match an account identifier included among the additional identity information. In the example above, the buyer account included in the header “X-CSP1-Buyer-Account-Id” may be matched to the “buyerCSP1AccountId” included in the additional identifiers.

At block 430, the computing system, responsive to validating the at least one additional identifier, generates a security token for accessing a service manager for a cloud service offered by the second cloud environment. For instance, the security token (e.g., an RPST token) for accessing the service manager (or control plane) for the cloud service offered by the second cloud environment can be issued or generated and provided to the downstream service manager or control plane as a bearer token proving identity or authentication to perform the requested operation. In some cases, the security token may additionally be used to prove authorizations or other provable assertions.

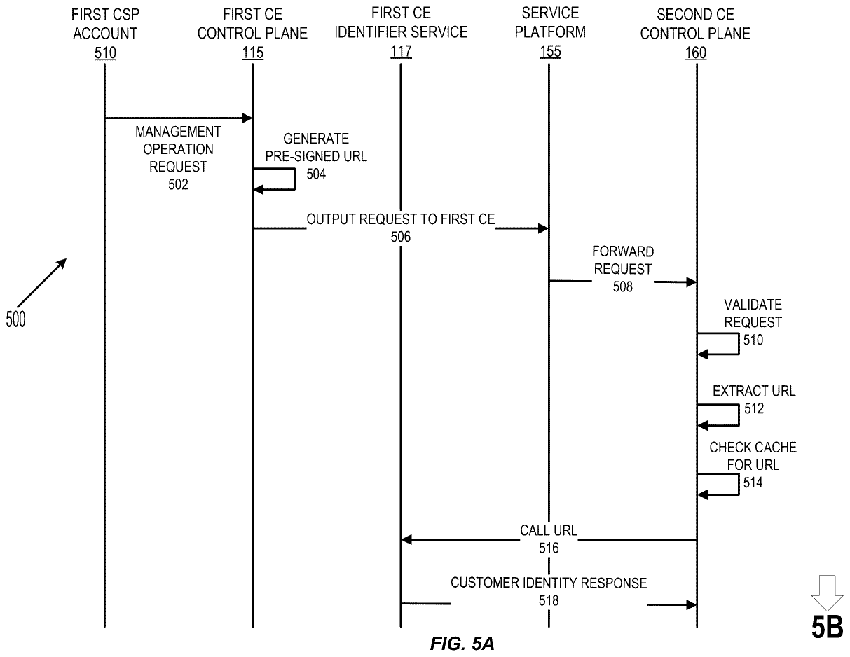

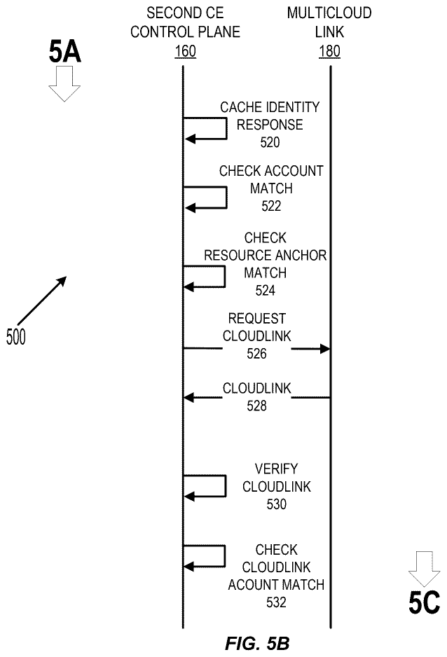

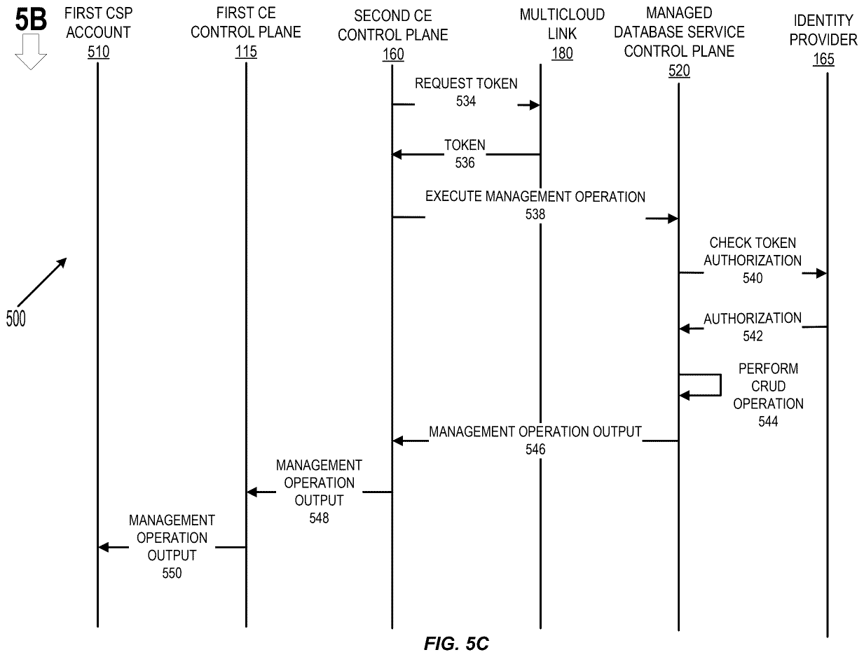

Referring now to FIGS. 5A-5C, FIGS. 5A-5C show a sequence diagram 500 of an example method for securing identity for multicloud operations, according to some aspects of the present disclosure. In particular, sequence diagram 500 shows an example implementation of the system 100 described shown in FIG. 1, in which the service manager 175 is a control plane for a managed database service offered by a second CSP. The description of the sequence diagram 500 in FIG. 5 will be made with reference to FIG. 1, however any suitable system according to this disclosure may be used. It should be appreciated that sequence diagram 500 provides a particular method for securing identity for multicloud operations. Other sequences of operations may also be performed according to alternative examples. For example, alternative examples of the present disclosure may perform the steps outlined below in a different order. Moreover, the individual operations illustrated by sequence diagram 500 may include multiple sub-operations that may be performed in various sequences as appropriate to the individual operation. Furthermore, additional operations may be added or removed depending on the particular applications. Further, the operations described in sequence diagram 500 may be performed by different devices. For example, the description is given from the perspective of a cloud environment (e.g., second cloud environment 150 of FIG. 1) but other configurations are possible. One of ordinary skill in the art would recognize many variations, modifications, and alternatives.

Sequence diagram 500 involves a first CSP, a second CSP, and customer of both CSPs. The customer may subscribe to services hosted in a first cloud environment provided by the first CSP and to services in a second cloud environment provided by a second CSP. While the customer may use services in the first cloud environment for certain purposes, it may be desirable to use services on the second cloud environment provided by the second CSP from time to time. For example, the second CSP may offer a particular database service that is not supported by the first CSP. In this case, for example, the customer can configure applications executing on compute instances in the first cloud environment provided by the first CSP to execute a database query against a managed database service in the second cloud environment provided by the second CSP.

The sequence diagram 500 begins with a first CSP account 510 causing an indication of a desired management operation 502 to be output to the first control plane 115 for the first cloud environment (cloud environment is abbreviated as “CE” in FIGS. 5A-5C) such as a database instance provisioning request or configuration update. The first CSP account 510 may be, for example, an account associated with a customer of both the first CSP and the second CSP. The first CSP account 510 may be an identity assumed by a user of a client device 130 accessing a software component in the first cloud environment (e.g., a console provided by the first CSP) or by an application executing in a compute instance 125.

For instance, the application executing in the first cloud environment may output a request to the second cloud environment (e.g., a REST API request or a remote query over a TCP/IP connection) to perform an operation in the second cloud environment. The requested operation may be a management operation to a managed database service control plane 520 in the second cloud environment provided by the second CSP. This example involves an application making a programmatic request, but the technique applies equally to any suitable application, daemon, delegate, role, administrator, or user (hereinafter the “caller”) that can be associated with accounts and/or roles of the customer. For example, the caller can use a programmatic or web-based API, command line interface (“CLI”), or other interface to request to perform the operation in the second cloud environment.

The “confused identity” problem arises here because the second cloud environment has not independently authenticated the caller. In other words, the second cloud environment could receive the request with instructions to perform a privileged action (e.g., query a database) but would have no proof that the requesting entity (in this example, the first CSP account 510), is who it claims to be. As described above, such a scenario is vulnerable to a “man in the middle” attack, in which a malicious user could impersonate the caller, directing the database service in the second cloud environment to execute database management operations that the customer has not authorized, leading to potentially very serious security compromises in the second cloud environment involving the managed database service. Thus, the first and second cloud environments 105, 150 are configured, using the innovations disclosed herein, such that the first control plane 115 does not forward the request directly to the target service manager or control plane for the managed database service.

At 504, the first control plane 115, upon receipt of the management operation request, generates a pre-signed URL using information about the caller obtained from a suitable source, such as the identity provider 110. For example, the first control plane 115 can use the caller's session credentials to create a cryptographically pre-signed URL. The pre-signed URL may be, for example, a URL for a web service in the first cloud environment that can be invoked to confirm the validity of other information included in the request such as an API provided by the identifier service 117. The URL may be pre-signed, which means that it includes a cryptographic signature generated by the first control plane 115 using a private key that is held only by the first CSP. Later, when the second cloud environment invokes the pre-signed URL, the endpoint associated with the URL can confirm that it was signed using a private key possessed by the first CSP, because the first CSP is the only possessor of the private key. For example, the endpoint associated with the URL can confirm this using the public key of the first CSP.

The pre-signed URL may, for example, include the digital signature in a query parameter as well as an expiration time (e.g., a UNIX timestamp). The pre-signed URL may be configured to expire in accordance with the security requirements of the particular application or organizational standards. For example, the expiration time may be 30 seconds, 5 minutes, 30 minutes, and so on, where shorter expiration times are more secure. In the example of an HTTP web service request, the pre-signed URL can be added to the headers, query parameters, or body of the request. Additional information may be added to the request such as an account identifier of the caller, other account identifiers, or identifiers for other entities.

At 506, the first control plane 115 forwards the request to the second cloud environment. In some examples, the request may be received by a service platform, such as the service platform 155 described in FIG. 1. The service platform 155 can act as middleware that unites standards and formats across the second cloud environment, enforces authentication and authorization procedures, and so on. At 508, the service platform 155 forwards the request to the second control plane 160 of the second cloud environment. In some examples, the forwarded request may be forwarded to “as-is,” while in other examples, may be adapted to organizational standards (e.g., reformatted headers, sanitized payloads, authentication token enforcement, etc.). the forwarded request is received by the second control plane 160.

At 510, the second control plane 160 first validates the request. For example, the second control plane 160 can verify that the required headers for securing identity for multicloud operations are present and correctly formatted. The second control plane 160 can also verify that the included pre-signed URL is signed (e.g., includes a digital signature as a query parameter) and that the signature is syntactically valid (e.g., has the correct number of bits, such as 256 bits for an ECDSA P-256 signature or 2048 bits for an RSA signature). At 512, the second control plane 160 extracts the pre-signed URL. For instance, the pre-signed URL may be included in the request as the value for a header with key “X-CSP1-PreSigned-Url”, such as “https://csp1.identifier.service.com/?signature=abcde12345”.

In some examples, the received pre-signed URLs can act as keys that can be cached along with the authorization information obtained from the identifier service 117 (or other pre-signed URL endpoint) as values. Then, instead of calling back to the first cloud environment every time a URL is received as part of a request to access a service in the second cloud environment, the cached authorization information can be used to reduce network congestion, conserve computational resources, among other reasons. Thus, prior to outputting the network request to the network location identified by the URL, the cache may be queried to determine if the URL is stored in the cache. At 514, the second control plane 160 queries the cache using the pre-signed URL. The cache may be, for example, an in-memory key-value store (e.g., Redis), files on a filesystem, ephemeral data structure in memory, and so on.

At 516, the second control plane 160 invokes the pre-signed URL. For example, the pre-signed URL may be a web-based API endpoint that can be invoked using an HTTP GET or HTTP request. In this example, the pre-signed URL invokes an API associated with the identifier service 117 of the first cloud environment, but other components may be used to similar effect. At 518, the identity information about the caller is received in response. The request may include an identifier of the caller, such as the alphanumeric account identifier associated with the user or user role that originated the request. The response may include additional information such as alternative identifiers of the user or role (e.g., an alphanumeric user identifier or “resource” identifier). In this context, a resource may refer generally to a uniquely addressable entity associated with the first CSP, such as a user or role identity.

At 520, the information returned from the network location accessed using the pre-signed URL is stored in the cache. For example, the pre-signed URL can be designated as the key and the value may include the caller's identifier as returned from the pre-signed URL endpoint (or the called identifier included in the original request). In examples in which the URLs have an associated expiration time, cache entries can be expired when the associated URL expires. For example, if the URL has an associated expiration time, the cache entry created using the pre-signed URL can be configured to expire coterminously when the associated URL becomes invalid.

At 522, the account identifier returned from the pre-signed URL endpoint is compared to the account identifier of the caller included in the original request at 504. If they do, the second control plane 160 thereby confirms that the identifier added to the request was added by the first CSP and not an attacker, and that the caller is an authorized caller associated with the account identifier. If they do not match, the operation can be aborted. In some examples, the process shown in sequence diagram 500 halts. In some examples, a response may be returned to the caller including an error message, a numerical identifier or classification of the error, or commands to cause an exception to be thrown in calling program code.

At 524, additional comparisons can be made. For example, the request may include additional identifiers of the caller such as resource identifiers used by the first CSP. The information returned in the response at 518 may likewise include a resource identifier, which can serve as an additional verification.

In some examples, at 526 and following the verifications made at 522 and 524, a “cloud link” object may be requested at the multicloud link 180. The cloud link object may be a data structure maintained by the multicloud link 180 that encapsulates the mapping between an account associated with the first CSP (and any authorized shared accounts) and the corresponding account associated with the second CSP. The cloud link object can be used to support authentication, authorization, policy enforcement, etc. for multicloud operations. The request to the multicloud link 180 may include an identifier included in the original request at 504. For example, a customer account (sometimes referred to as the “buyer”) can be associated with authorized multicloud operations and may be included in the original request. The identifier of the buyer account may be stored at the multicloud link 180. The request to the multicloud link 180 may thus include the buyer identifier. At 528, if the buyer identifier matches an identifier stored at the multicloud link 180, a cloud link object is returned, along with additional identifiers such as the buyer identifier and account identifiers configured as shared accounts that may be used for multicloud operations along with the buyer account. At 530, the response from the multicloud link 180 is validated and the presence of the cloud link object is verified. At 532, the second control plane 160 verifies that the caller account identifier is among those returned by the multicloud link 180. This verification in effect confirms that the first CSP and the second CSP agree that the calling account is authorized for multicloud operations (although not necessarily authorized for the particular requested operation).

Following verification that the calling account is authorized for multicloud operations, at 534 the second control plane 160 requests a token from the multicloud link 180. In some examples, the token may be requested from other components such as the identity provider 165 of FIG. 1. The token is received at 536. The token may be an RPST token that can be used as a bearer token for authorizing operations at the downstream managed database service control plane 520. For example, the RPST can be used to limit the allowed operations to those that are authorized by the policies encoded in the token. For instance, the RPST may include structured data fields representing the caller's verified identity, mapped entities in the second cloud environment, explicit authorizations, etc. within a cryptographically signed payload that can be verified by the managed database service control plane 520 prior to executing the requested operations.

At 538, the second control plane 160 outputs a command to cause the requested management operation to be executed by the managed database service control plane 520. At 540, the managed database service control plane 520 forwards the token to the identity provider 165 to verify its authenticity and validity. At 542, the identity provider 165 returns information regarding the authorization of first CSP account 510 to perform the requested management operation. For example, the identity provider 165 may return a data structure that includes allowed scopes or operations.

At 544, the managed database service control plane 520 performs the authorized management operation. At 546, 548, and 550, the output of the management operation (e.g., a data structure including a number of rows returned following a query) is forwarded to the second control plane 160, the first control plane 115, and then back to the calling first CSP account 510, respectively, sequentially.

Sequence diagram 500 concerns an example of a management operation request originating from the first CSP account 510. However, in some examples, the sequence illustrated in sequence diagram 500 may be used to mitigate or prevent the confused identity vulnerability in the context of data plane operations. In this example, a database instance, storage bucket, virtual machine, container cluster, load balancer, message queue, etc. could be used or operated via a suitable request using the techniques described in this sequence diagram 500.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers'on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 11, 12, 13, and 14 (see references 1116, 1216, 1316, and 1416) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 6, 7, 8, 9, 10, 11, 12, 13, and 14, and are described below. FIG. 6 is a high level diagram of a distributed environment 600 showing an overlay or customer VCN hosted by CSPI according to certain embodiments. The distributed environment depicted in FIG. 6 includes multiple components in the overlay network. Distributed environment 600 depicted in FIG. 6 is merely an example and is not intended to unduly limit the scope of claimed embodiments. Many variations, alternatives, and modifications are possible. For example, in some implementations, the distributed environment depicted in FIG. 6 may have more or fewer systems or components than those shown in FIG. 1, may combine two or more systems, or may have a different configuration or arrangement of systems.

As shown in the example depicted in FIG. 6, distributed environment 600 comprises CSPI 601 that provides services and resources that customers can subscribe to and use to build their virtual cloud networks (VCNs). In certain embodiments, CSPI 601 offers IaaS services to subscribing customers. The data centers within CSPI 601 may be organized into one or more regions. One example region “Region US” 602 is shown in FIG. 6. A customer has configured a customer VCN 604 for region 602. The customer may deploy various compute instances on VCN 604, where the compute instances may include virtual machines or bare metal instances. Examples of instances include applications, database, load balancers, and the like.

In the embodiment depicted in FIG. 6, customer VCN 604 comprises two subnets, namely, “Subnet-1” and “Subnet-2”, each subnet with its own CIDR IP address range. In FIG. 6, the overlay IP address range for Subnet-1 is 10.0/16 and the address range for Subnet-2 is 10.1/16. A VCN Virtual Router 605 represents a logical gateway for the VCN that enables communications between subnets of the VCN 604, and with other endpoints outside the VCN. VCN VR 605 is configured to route traffic between VNICs in VCN 604 and gateways associated with VCN 604. VCN VR 605 provides a port for each subnet of VCN 604. For example, VR 605 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 601. A compute instance participates in a subnet via a VNIC associated with the compute instance. For example, as shown in FIG. 6, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 6, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 605 using IP address 10.0.0.1, which is the IP address for a port of VCN VR 605 for Subnet-1.

Subnet-2 can have multiple compute instances deployed on it, including virtual machine instances and/or bare metal instances. For example, as shown in FIG. 6, compute instances D1 and D2 are part of Subnet-2 via VNICs associated with the respective compute instances. In the embodiment depicted in FIG. 6, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 605 using IP address 10.1.0.1, which is the IP address for a port of VCN VR 605 for Subnet-2.

VCN A 604 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 604 can communicate with various different endpoints. These endpoints may include endpoints that are hosted by CSPI 700 and endpoints outside CSPI 700. Endpoints that are hosted by CSPI 601 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 606 or 610, communications between a compute instance in Subnet-1 and an endpoint in service network 610 in the same region); or an endpoint in a VCN in a different region (e.g., communications between a compute instance in Subnet-1 and an endpoint in a VCN in a different region 608). A compute instance in a subnet hosted by CSPI 601 may also communicate with endpoints that are not hosted by CSPI 601 (i.e., are outside CSPI 601). These outside endpoints include endpoints in the customer's on-premise network 616, endpoints within other remote cloud hosted networks 618, public endpoints 614 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 6 wants to send a packet to compute instance D1 in Subnet-2, the packet is first processed by the VNIC associated with compute instance C1. The VNIC associated with compute instance C1 is configured to route the packet to the VCN VR 605 using default route or port 10.0.0.1 of the VCN VR. VCN VR 605 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 604 to an endpoint that is outside VCN 604, the communication is facilitated by the VNIC associated with the source compute instance, VCN VR 605, and gateways associated with VCN 604. One or more types of gateways may be associated with VCN 604. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 604. The packet may be first processed by the VNIC associated with source compute instance C1. The VNIC processing determines that the destination for the packet is outside the Subnet-1 of C1. The VNIC associated with C1 may forward the packet to VCN VR 605 for VCN 604. VCN VR 605 then processes the packet and as part of the processing, based upon the destination for the packet, determines a particular gateway associated with VCN 604 as the next hop for the packet. VCN VR 605 may then forward the packet to the particular identified gateway. For example, if the destination is an endpoint within the customer's on-premise network, then the packet may be forwarded by VCN VR 605 to Dynamic Routing Gateway (DRG) gateway 622 configured for VCN 604. The packet may then be forwarded from the gateway to a next hop to facilitate communication of the packet to it final intended destination.

Various different types of gateways may be configured for a VCN. Examples of gateways that may be configured for a VCN are depicted in FIG. 6 and described below. Examples of gateways associated with a VCN are also depicted in FIGS. 11, 12, 13, and 14 (for example, gateways referenced by reference numbers 1134, 1136, 1138, 1234, 1236, 1238, 1334, 1336, 1338, 1434, 1436, and 1438) and described below. As shown in the embodiment depicted in FIG. 6, a Dynamic Routing Gateway (DRG) 622 may be added to or be associated with customer VCN 604 and provides a path for private network traffic communication between customer VCN 604 and another endpoint, where the another endpoint can be the customer's on-premise network 616, a VCN 608 in a different region of CSPI 601, or other remote cloud networks 618 not hosted by CSPI 601. Customer on-premise network 616 may be a customer network or a customer data center built using the customer's resources. Access to customer on-premise network 616 is generally very restricted. For a customer that has both a customer on-premise network 616 and one or more VCNs 604 deployed or hosted in the cloud by CSPI 601, the customer may want their on-premise network 616 and their cloud-based VCN 604 to be able to communicate with each other. This enables a customer to build an extended hybrid environment encompassing the customer's VCN 604 hosted by CSPI 601 and their on-premises network 616. DRG 622 enables this communication. To enable such communications, a communication channel 624 is set up where one endpoint of the channel is in customer on-premise network 616 and the other endpoint is in CSPI 601 and connected to customer VCN 604. Communication channel 624 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 616 that forms one end point for communication channel 624 is referred to as the customer premise equipment (CPE), such as CPE 626 depicted in FIG. 6. On the CSPI 601 side, the endpoint may be a host machine executing DRG 622.

In certain embodiments, a Remote Peering Connection (RPC) can be added to a DRG, which allows a customer to peer one VCN with another VCN in a different region. Using such an RPC, customer VCN 604 can use DRG 622 to connect with a VCN 608 in another region. DRG 622 may also be used to communicate with other remote cloud networks 618, not hosted by CSPI 601 such as a Microsoft Azure cloud, Amazon AWS cloud, and others.

As shown in FIG. 6, an Internet Gateway (IGW) 620 may be configured for customer VCN 604 the enables a compute instance on VCN 604 to communicate with public endpoints 614 accessible over a public network such as the Internet. IGW 620 is a gateway that connects a VCN to a public network such as the Internet. IGW 620 enables a public subnet (where the resources in the public subnet have public overlay IP addresses) within a VCN, such as VCN 604, direct access to public endpoints 612 on a public network 614 such as the Internet. Using IGW 620, connections can be initiated from a subnet within VCN 604 or from the Internet.

A Network Address Translation (NAT) gateway 628 can be configured for customer's VCN 604 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 604, with private access to public endpoints on the Internet. In NAT gateways, connections can be initiated only from the private subnet to the public Internet and not from the Internet to the private subnet.

In certain embodiments, a Service Gateway (SGW) 626 can be configured for customer VCN 604 and provides a path for private network traffic between VCN 604 and supported services endpoints in a service network 610. In certain embodiments, service network 610 may be provided by the CSP and may provide various services. An example of such a service network is Oracle's Services Network, which provides various services that can be used by customers. For example, a compute instance (e.g., a database system) in a private subnet of customer VCN 604 can back up data to a service endpoint (e.g., Object Storage) without needing public IP addresses or access to the Internet. In certain embodiments, a VCN can have only one SGW, and connections can only be initiated from a subnet within the VCN and not from service network 610. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 626 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 632 is a gateway that can be added to customer VCN 604 and enables VCN 604 to peer with another VCN in the same region. Peering means that the VCNs communicate using private IP addresses, without the traffic traversing a public network such as the Internet or without routing the traffic through the customer's on-premises network 616. In preferred embodiments, a VCN has a separate LPG for each peering it establishes. Local Peering or VCN Peering is a common practice used to establish network connectivity between different applications or infrastructure management functions.

Service providers, such as providers of services in service network 610, may provide access to services using different access models. According to a public access model, services may be exposed as public endpoints that are publicly accessible by compute instance in a customer VCN via a public network such as the Internet and or may be privately accessible via SGW 626. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 630 is a gateway resource that can be attached to a service provider VCN (e.g., a VCN in service network 610) that acts as an ingress/egress point for all traffic from/to customer subnet private endpoints. PAGW 630 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 630 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 632 and the PE in the customer's VCN.

A customer can control routing in a VCN at the subnet level, so the customer can specify which subnets in the customer's VCN, such as VCN 604, use each gateway. A VCN's route tables are used to decide if traffic is allowed out of a VCN through a particular gateway. For example, in a particular instance, a route table for a public subnet within customer VCN 604 may send non-local traffic through IGW 620. The route table for a private subnet within the same customer VCN 604 may send traffic destined for CSP services through SGW 626. All remaining traffic may be sent via the NAT gateway 628. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 604) can be categorized as public access, private access, or dedicated access. Public access refers to an access model where a public IP address or a NAT is used to access a public endpoint. Private access enables customer workloads in VCN 604 with private IP addresses (e.g., resources in a private subnet) to access services without traversing a public network such as the Internet. In certain embodiments, CSPI 601 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

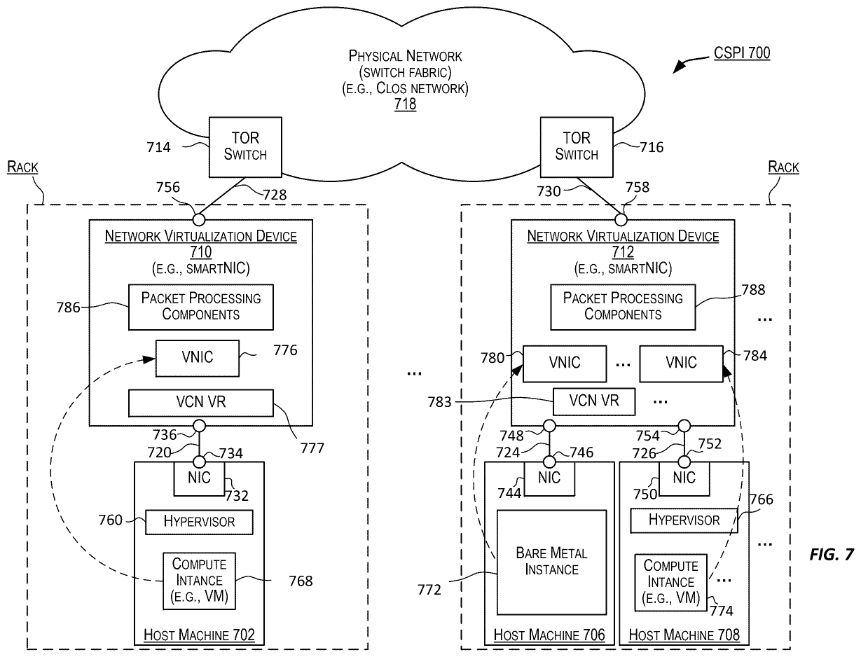

FIG. 6 and the accompanying description above describes various virtualized components in an example virtual network. As described above, the virtual network is built on the underlying physical or substrate network. FIG. 7 depicts a simplified architectural diagram of the physical components in the physical network within CSPI 700 that provide the underlay for the virtual network according to certain embodiments. As shown, CSPI 700 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 700 are provisioned for the customer. Customers can then build their own cloud-based (i.e., CSPI-hosted) customizable and private virtual networks using physical compute, memory, and networking resources provided by CSPI 700. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 700 provides infrastructure and a set of complementary cloud services that enable customers to build and run a wide range of applications and services in a highly available hosted environment.

In the example embodiment depicted in FIG. 7, the physical components of CSPI 700 include one or more physical host machines or physical servers (e.g., 702, 706, 708), network virtualization devices (NVDs) (e.g., 710, 712), top-of-rack (TOR) switches (e.g., 714, 716), and a physical network (e.g., 718), and switches in physical network 718. The physical host machines or servers may host and execute various compute instances that participate in one or more subnets of a VCN. The compute instances may include virtual machine instances, and bare metal instances. For example, the various compute instances depicted in FIG. 6 may be hosted by the physical host machines depicted in FIG. 7. The virtual machine compute instances in a VCN may be executed by one host machine or by multiple different host machines. The physical host machines may also host virtual host machines, container-based hosts or functions, and the like. The VNICs and VCN VR depicted in FIG. 6 may be executed by the NVDs depicted in FIG. 7. The gateways depicted in FIG. 6 may be executed by the host machines and/or by the NVDs depicted in FIG. 7.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 7, host machines 702 and 708 execute hypervisors 760 and 766, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 7, hypervisor 760 may sit on top of the OS of host machine 702 and enables the computing resources (e.g., processing, memory, and networking resources) of host machine 702 to be shared between compute instances (e.g., virtual machines) executed by host machine 702. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 7 may have the same or different types of hypervisors.

A compute instance can be a virtual machine instance or a bare metal instance. In FIG. 7, compute instances 768 on host machine 702 and 774 on host machine 708 are examples of virtual machine instances. Host machine 706 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 7, host machine 702 executes a virtual machine compute instance 768 that is associated with VNIC 776, and VNIC 776 is executed by NVD 710 connected to host machine 702. As another example, bare metal instance 772 hosted by host machine 706 is associated with VNIC 780 that is executed by NVD 712 connected to host machine 706. As yet another example, VNIC 784 is associated with compute instance 774 executed by host machine 708, and VNIC 784 is executed by NVD 712 connected to host machine 708.

For compute instances hosted by a host machine, an NVD connected to that host machine also executes VCN VRs corresponding to VCNs of which the compute instances are members. For example, in the embodiment depicted in FIG. 7, NVD 710 executes VCN VR 777 corresponding to the VCN of which compute instance 768 is a member. NVD 712 may also execute one or more VCN VRs 783 corresponding to VCNs corresponding to the compute instances hosted by host machines 706 and 708.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 7, host machine 702 is connected to NVD 710 using link 720 that extends between a port 734 provided by a NIC 732 of host machine 702 and between a port 736 of NVD 710. Host machine 706 is connected to NVD 712 using link 724 that extends between a port 746 provided by a NIC 744 of host machine 706 and between a port 748 of NVD 712. Host machine 708 is connected to NVD 712 using link 726 that extends between a port 752 provided by a NIC 750 of host machine 708 and between a port 754 of NVD 712.

The NVDs are in turn connected via communication links to top-of-the-rack (TOR) switches, which are connected to physical network 718 (also referred to as the switch fabric). In certain embodiments, the links between a host machine and an NVD, and between an NVD and a TOR switch are Ethernet links. For example, in FIG. 7, NVDs 710 and 712 are connected to TOR switches 714 and 716, respectively, using links 728 and 730. In certain embodiments, the links 720, 724, 726, 728, and 730 are Ethernet links. The collection of host machines and NVDs that are connected to a TOR is sometimes referred to as a rack.

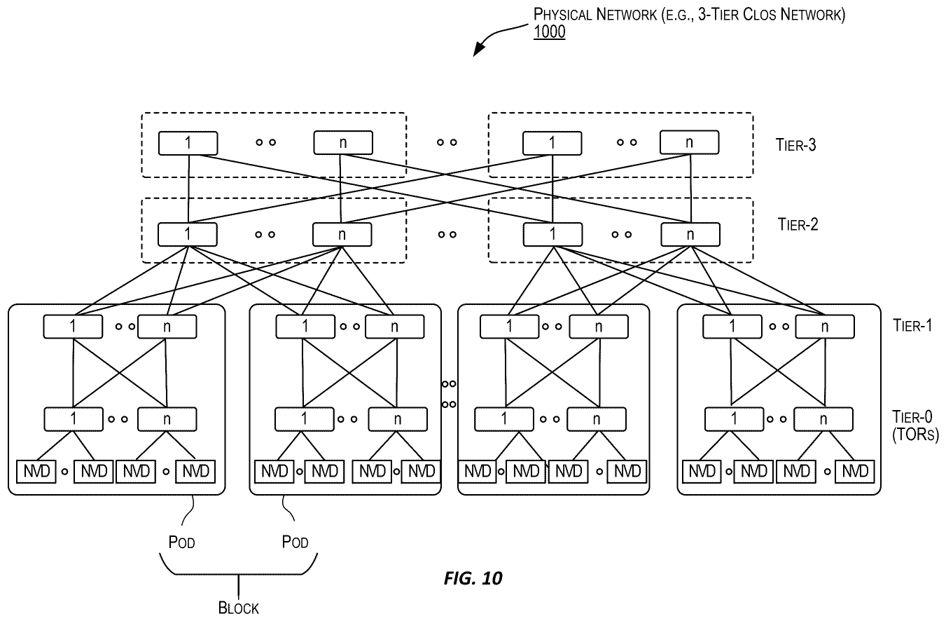

Physical network 718 provides a communication fabric that enables TOR switches to communicate with each other. Physical network 718 can be a multi-tiered network. In certain implementations, physical network 718 is a multi-tiered Clos network of switches, with TOR switches 714 and 716 representing the leaf level nodes of the multi-tiered and multi-node physical switching network 718. Different Clos network configurations are possible including but not limited to a 2-tier network, a 3-tier network, a 4-tier network, a 5-tier network, and in general a “n”-tiered network. An example of a Clos network is depicted in FIG. 10 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 7, host machine 702 is connected to NVD 710 via NIC 732 of host machine 702. In a many-to-one configuration, multiple host machines are connected to one NVD. For example, in FIG. 7, host machines 706 and 708 are connected to the same NVD 712 via NICs 744 and 750, respectively.

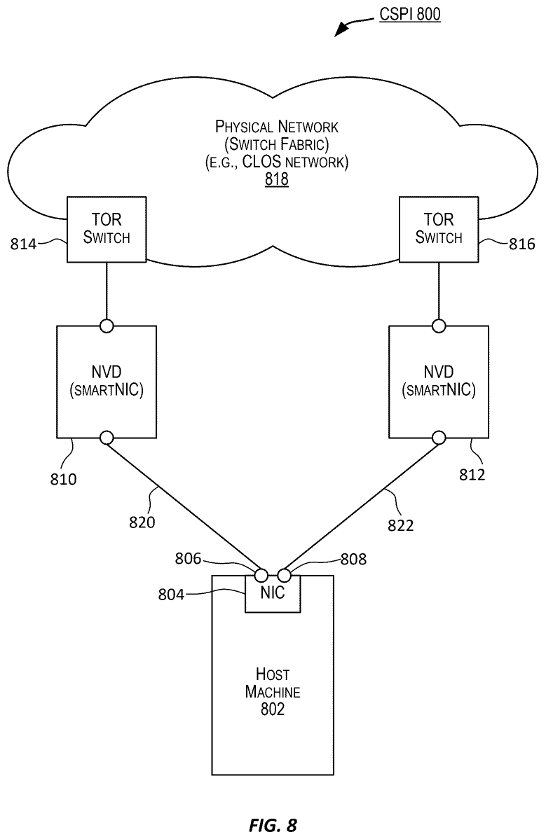

In a one-to-many configuration, one host machine is connected to multiple NVDs. FIG. 8 shows an example within CSPI 800 where a host machine is connected to multiple NVDs. As shown in FIG. 8, host machine 802 comprises a network interface card (NIC) 804 that includes multiple ports 806 and 808. Host machine 800 is connected to a first NVD 810 via port 806 and link 820, and connected to a second NVD 812 via port 808 and link 822. Ports 806 and 808 may be Ethernet ports and the links 820 and 822 between host machine 802 and NVDs 810 and 812 may be Ethernet links. NVD 810 is in turn connected to a first TOR switch 814 and NVD 812 is connected to a second TOR switch 816. The links between NVDs 810 and 812, and TOR switches 814 and 816 may be Ethernet links. TOR switches 814 and 816 represent the Tier-0 switching devices in multi-tiered physical network 818.

The arrangement depicted in FIG. 8 provides two separate physical network paths to and from physical switch network 818 to host machine 802: a first path traversing TOR switch 814 to NVD 810 to host machine 802, and a second path traversing TOR switch 816 to NVD 812 to host machine 802. The separate paths provide for enhanced availability (referred to as high availability) of host machine 802. If there are problems in one of the paths (e.g., a link in one of the paths goes down) or devices (e.g., a particular NVD is not functioning), then the other path may be used for communications to/from host machine 802.

In the configuration depicted in FIG. 8, the host machine is connected to two different NVDs using two different ports provided by a NIC of the host machine. In other embodiments, a host machine may include multiple NICs that enable connectivity of the host machine to multiple NVDs.

Referring back to FIG. 7, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 7, the NVDs 710 and 712 may be implemented as smartNICs that are connected to host machines 702, and host machines 706 and 708, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 700. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 7, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 7 include port 736 on NVD 710, and ports 748 and 754 on NVD 712. A network-facing port of an NVD is a port that is used to connect the NVD to a TOR switch. Examples of network-facing ports in FIG. 7 include port 756 on NVD 710, and port 758 on NVD 712. As shown in FIG. 7, NVD 710 is connected to TOR switch 714 using link 728 that extends from port 756 of NVD 710 to the TOR switch 714. Likewise, NVD 712 is connected to TOR switch 716 using link 730 that extends from port 758 of NVD 712 to the TOR switch 716.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 11, 12, 13, and 14 (see references 1116, 1216, 1316, and 1416) and described below. Examples of a VCN Data Plane are depicted in FIGS. 11, 12, 13, and 14 (see references 1118, 1218, 1318, and 1418) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 7, NVD 710 executes the functionality for VNIC 776 that is associated with compute instance 768 hosted by host machine 702 connected to NVD 710. As another example, NVD 712 executes VNIC 780 that is associated with bare metal compute instance 772 hosted by host machine 706, and executes VNIC 784 that is associated with compute instance 774 hosted by host machine 708. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 7, NVD 710 executes VCN VR 777 corresponding to the VCN to which compute instance 768 belongs. NVD 712 executes one or more VCN VRs 783 corresponding to one or more VCNs to which compute instances hosted by host machines 706 and 708 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 7. For example, NVD 710 comprises packet processing components 786 and NVD 712 comprises packet processing components 788. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 6 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 6 may be executed or hosted by one or more of the physical components depicted in FIG. 7. For example, the compute instances in a VCN may be executed or hosted by one or more host machines depicted in FIG. 7. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 7, a packet originating from compute instance 768 may be communicated from host machine 702 to NVD 710 over link 720 (using NIC 732). On NVD 710, VNIC 776 is invoked since it is the VNIC associated with source compute instance 768. VNIC 776 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 700 and endpoints outside CSPI 700. Endpoints hosted by CSPI 700 may include instances in the same VCN or other VCNs, which may be the customer's VCNs, or VCNs not belonging to the customer. Communications between endpoints hosted by CSPI 700 may be performed over physical network 718. A compute instance may also communicate with endpoints that are not hosted by CSPI 700, or are outside CSPI 700. Examples of these endpoints include endpoints within a customer's on-premise network or data center, or public endpoints accessible over a public network such as the Internet. Communications with endpoints outside CSPI 700 may be performed over public networks (e.g., the Internet) (not shown in FIG. 7) or private networks (not shown in FIG. 7) using various communication protocols.

The architecture of CSPI 700 depicted in FIG. 7 is merely an example and is not intended to be limiting. Variations, alternatives, and modifications are possible in alternative embodiments. For example, in some implementations, CSPI 700 may have more or fewer systems or components than those shown in FIG. 7, may combine two or more systems, or may have a different configuration or arrangement of systems. The systems, subsystems, and other components depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

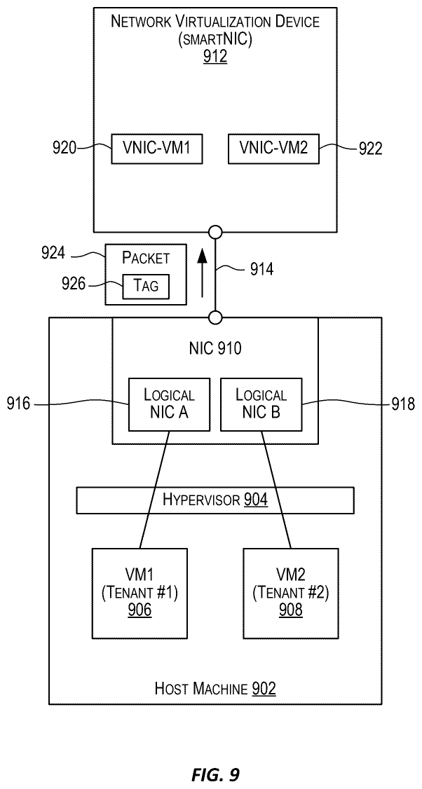

FIG. 9 depicts connectivity between a host machine and an NVD for providing I/O virtualization for supporting multitenancy according to certain embodiments. As depicted in FIG. 9, host machine 902 executes a hypervisor 904 that provides a virtualized environment. Host machine 902 executes two virtual machine instances, VM1 906 belonging to customer/tenant #1 and VM2 908 belonging to customer/tenant #2. Host machine 902 comprises a physical NIC 910 that is connected to an NVD 912 via link 914. Each of the compute instances is attached to a VNIC that is executed by NVD 912. In the embodiment in FIG. 9, VM1 906 is attached to VNIC-VM1 920 and VM2 908 is attached to VNIC-VM2 922.

As shown in FIG. 9, NIC 910 comprises two logical NICs, logical NIC A 916 and logical NIC B 918. Each virtual machine is attached to and configured to work with its own logical NIC. For example, VM1 906 is attached to logical NIC A 916 and VM2 908 is attached to logical NIC B 918. Even though host machine 902 comprises only one physical NIC 910 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 916 for Tenant #1 and a separate VLAN ID is assigned to logical NIC B 918 for Tenant #2. When a packet is communicated from VM1 906, a tag assigned to Tenant #1 is attached to the packet by the hypervisor and the packet is then communicated from host machine 902 to NVD 912 over link 914. In a similar manner, when a packet is communicated from VM2 908, a tag assigned to Tenant #2 is attached to the packet by the hypervisor and the packet is then communicated from host machine 902 to NVD 912 over link 914. Accordingly, a packet 924 communicated from host machine 902 to NVD 912 has an associated tag 926 that identifies a specific tenant and associated VM. On the NVD, for a packet 924 received from host machine 902, the tag 926 associated with the packet is used to determine whether the packet is to be processed by VNIC-VM1 920 or by VNIC-VM2 922. The packet is then processed by the corresponding VNIC. The configuration depicted in FIG. 9 enables each tenant's compute instance to believe that they own their own host machine and NIC. The setup depicted in FIG. 9 provides for I/O virtualization for supporting multi-tenancy.

FIG. 10 depicts a simplified block diagram of a physical network 1000 according to certain embodiments. The embodiment depicted in FIG. 10 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 10 is a 3-tiered network comprising tiers 1, 2, and 3. The TOR switches 1004 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 10, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1000 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
Ocid1.<resource Type>.<realm>.[region][.Future Use].<unique Id>
where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service

### Example Infrastructure as a Service (IaaS) Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

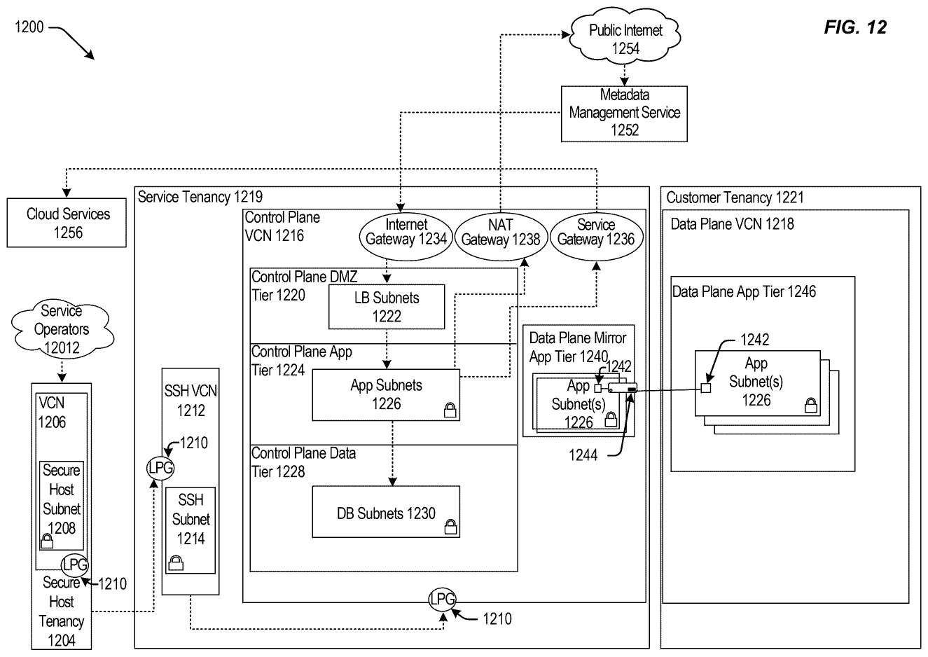

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

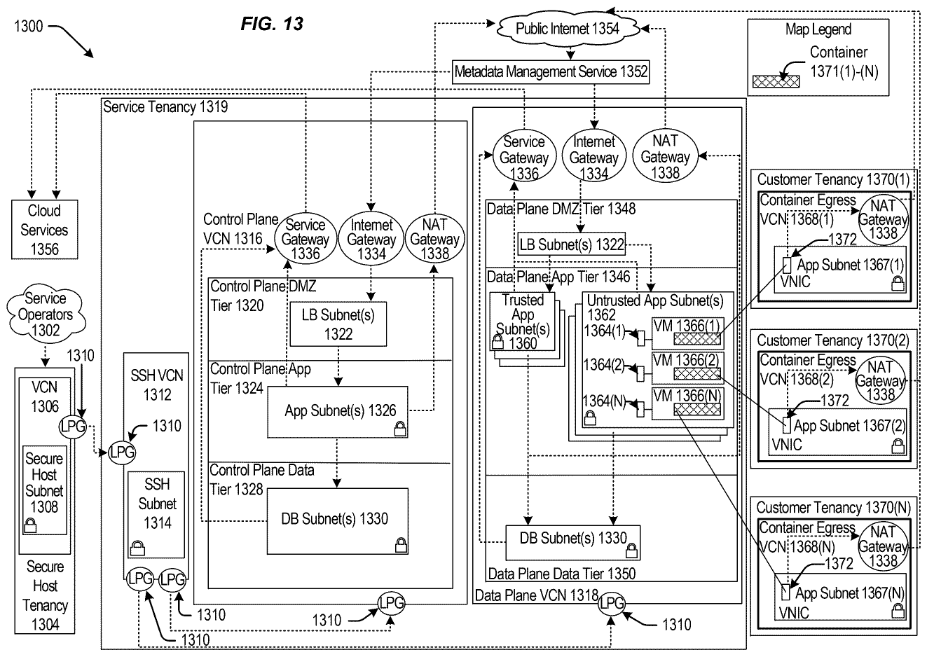

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

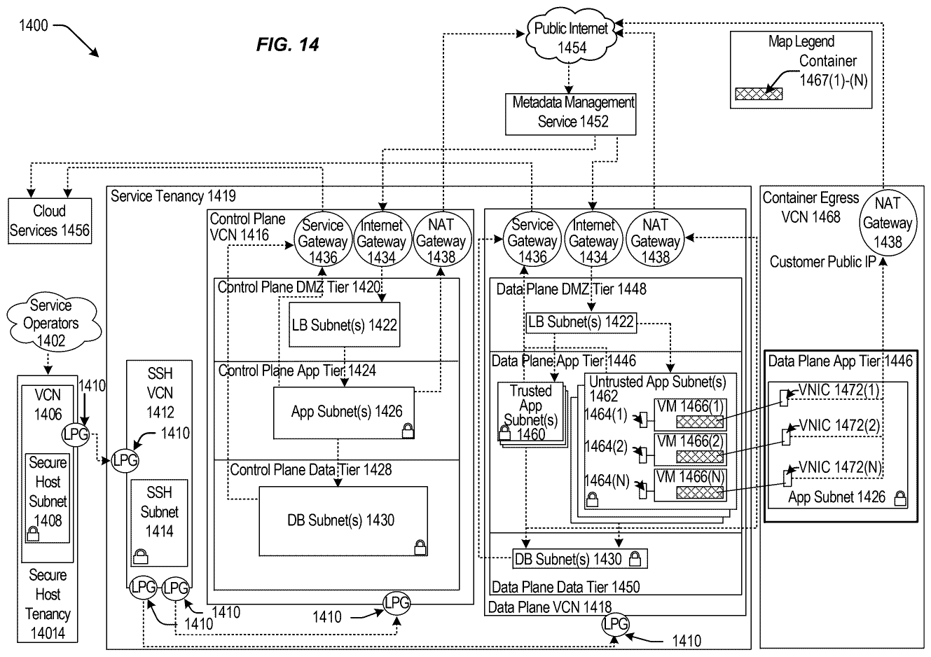

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### Example Multicloud Architecture

FIG. 16 depicts a simplified high-level diagram of a distributed environment 1600 comprising multiple cloud environments provided by different cloud service providers (CSPs) wherein the cloud environments include a particular cloud environment that provides specialized infrastructure that enables one or more cloud services provided by that particular cloud environment to be used by customers of other cloud environments according to certain embodiments. As depicted in FIG. 16, various different cloud environments (also referred to as “clouds”) may be provided by different cloud service providers (CSPs), each cloud environment or cloud offering one or more cloud services that can be subscribed to by one or more customers of that cloud environment. The set of cloud services offered by a cloud environment provided by a CSP may include one or more different types of cloud services including but not restricted to Software-as-a-Service (SaaS) services, Infrastructure-as-a-Service (IaaS) services, Platform-as-a-Service (PaaS) services, Database-as-a-Service (DBaaS) services, and others. Examples of cloud environments provided by various CSPs include Oracle® Cloud Infrastructure (OCI) provided by Oracle Corporation, Microsoft® Azure provided by Microsoft Corporation, Google Cloud™ provided by Google LLC, Amazon Web Services (AWS®) provided by Amazon Corporation, and others. The cloud services offered by a particular cloud environment may be different from the set of cloud services offered by another cloud environment.

In a typical cloud environment, a CSP provides cloud service provider infrastructure (CSPI) that is used to provide the one or more cloud services that are offered by that cloud environment to its customers. The CSPI provided by a CSP may include various types of hardware and software resources including compute resources, memory resources, networking resources, consoles for accessing the cloud services, and others. A customer of a cloud environment provided by a CSP may subscribe to one or more of the cloud services offered by that cloud environment. Various subscription models may be offered by the CSP to its customers. After a customer subscribes to a cloud service provided by a cloud environment, one or more users may be associated with the subscribing customer and these users can use the cloud service subscribed to by the customer. In certain implementations, when a customer subscribes to a cloud service provided by a particular cloud environment, a customer account or customer tenancy is created for that customer. One or more users can then be associated with the customer tenancy and these users can then use the services subscribed to by the customer under the customer tenancy. Information regarding the services subscribed to by a customer, the users associated with the customer tenancy, etc., is usually stored within the cloud environment and associated with the customer tenancy.

For example, three different cloud environments provided by three different CSPs are depicted in FIG. 16. These include a Cloud Environment A (cloud A) 1610 provided by a CSP A, a Cloud Environment B (cloud B) %170 provided by a CSP B, and a Cloud Environment C (cloud C) 1660 provided by a CSP C. Cloud A 1610 includes infrastructure CSPI_A 1612 provided by CSP A, and this infrastructure may be used to provide a set of services “Services A” 1617 offered by cloud A 1610. One or more customers (e.g., Cust_A1 1616-1, Cust_A2 1616-2) may subscribe to one or more services from Services A 1617 provided by cloud A 1610. One or more users 1618-1 may be associated with Customer A1 1616-1 and can use the services subscribed to by customer A1 1616-1 in cloud A 1610. In a similar manner, one or more users 1618-2 may be associated with customer A2 1616-2 and can use the services subscribed to by customer A2 1616-2 in cloud A 1610. In various use cases, the services subscribed to by customer A1 1616-1 may be different from the services subscribed to by customer A2 1616-2.

As depicted in FIG. 16, cloud B %170 includes infrastructure CSPI_B %172 provided by CSP B, and this infrastructure may be used to provide a set of services “Services B” %174 offered by cloud B %170. One or more customers (e.g., Cust_B1 1616-1) may subscribe to one or more services from Services B %174. One or more users %178-1 may be associated with Customer B1 1616-1 and can use the services subscribed to by customer B1 1616-1 in cloud B %170.

As depicted in FIG. 16, cloud C 1660 includes infrastructure CSPI_C 1662 provided by CSP C, and this infrastructure may be used to provide a set of services “Services C” 1664 offered by cloud C 1660. One or more customers (e.g., Cust_C1 1616-1) may subscribe to one or more services from Services C 1664. One or more users 1668-1 may be associated with Customer C1 1616-1 and can use the services subscribed to by customer C1 1616-1 in cloud C 1660. It is to be noted that Services A 1617, Services B %174, and Services C 1664 can be different from each other.

In some cloud implementations, each cloud provides a closed ecosystem for its subscribing customers and associated users. As a result, a customer of a cloud environment and its associated users are restricted to using the services offered by the cloud that the customer subscribes to. For example, customer B1 1616-1 and its users %178-1 are restricted to using services B %174 provided by cloud B %170 and cannot use their account in cloud B %170 to access services from a different cloud environment, such as a services from services A 1617 offered by cloud A 1610 or a service from Services C 1664 offered by cloud C 1660. The teachings described herein overcome this limitation.

In some examples, techniques can be used that enable a link to be created between two cloud environments that enables a service provided by a first cloud environment provided by a first CSP to be used by a customer (and associated users) of a second different cloud environment provided by a second different CSP, using the customer's account in the second cloud environment.

For example, in the embodiment depicted in FIG. 16, infrastructure CSPI_A 1612 provided by CSP A, in addition to other infrastructure 1620, includes special infrastructure 1622 (referred to as multi-cloud enabling infrastructure 1622 or MEI 1622 or multi-cloud infrastructure 1622) that enables one or more services 1617 offered by cloud A to be used by customers and associated users of other clouds, such as clouds B %170 and C 1660, using the customer accounts in those other clouds. In certain implementations, customers of clouds B and C do not have to open separate accounts with cloud A to use one or more of services 1617 offered by cloud A 1610.

A customer B1 1616-1 of cloud B %170 and an associated user %178-1 can use their customer account or tenancy in cloud B %170 to use one or more services 1617 provided by cloud A 1610. As another example, a customer C1 1616-1 of cloud C 1660 and an associated user 1668-1 can use their customer account or tenancy in cloud C 1660 to use one or more services 1617 provided by cloud A 1610.

In certain implementations, MEI 1622 enables links to be created between cloud A 1610 and other clouds, where these links can be used by customers of the other clouds and their associated users to access and make use of services provided by cloud A 1610. This is symbolically shown in FIG. 16 as a link 1670 created between cloud A 1610 and cloud B %170, and a link 1672 created between cloud A 1610 and cloud C 1660. Via link 1670, a customer of cloud B %170 can access or use one or more services 1617 provided by cloud A 1610. Likewise, via link 1672, a customer of cloud C 1660 can access or use one or more services 1617 provided by cloud A 1610.

There are different ways in which MEI 1612 may be implemented. In certain embodiments, MEI 1612 may include components that enable links to be established with different clouds. For example, in FIG. 16, MEI 1622 includes an infrastructure component 1624 that is responsible for enabling link 1670 with cloud B %170, and an infrastructure component 1626 for enabling link 1672 with cloud C 1660. In a similar manner, MEI 1622 may include other components that enable and facilitate links with other clouds. In some implementations, a component of MEI 1622 may also facilitate links with multiple different clouds.

There are several reasons why a customer of one cloud may want or desire to use a cloud service provided by a different cloud. Using FIG. 16 as an example, there are multiple reasons why a customer B1 1616-1 of cloud B %170 may want to use a cloud service 1617 provided by cloud A 1610. In one use case scenario, this may happen because cloud A 1610 offers a cloud service with functionality that is not provided by cloud B %170. As another use case scenario, clouds A and B may offer a similar service, but the service provided by cloud A 1610 may be better (e.g., more features/functionality, faster, etc.) that the corresponding service offered by cloud B %170. As yet another use case scenario, customer B1 1616-1 of cloud B %170 may want to use a cloud service provided by cloud A 1610 because the service is provided at a cheaper price point than by cloud B %170. In some cases, there may be geographical restrictions or other reasons why customer B1 1616-1 of cloud B %170 might want to use a cloud service provided by cloud A 1610. For example, cloud A 1610 may offer the desired service in a geographical area that is not serviced by cloud B %170, or the particular service is not provided by cloud B %170 in a geographical area in which the customer desires the service. Several other use case scenarios are also possible as to why a customer of one cloud might want to use a service provided by a different cloud.

In certain embodiments, MEI 1622 provides capabilities and performs functions for creating the link between cloud A 1610 and another cloud, and via the link, enabling a user associated with a customer of the other cloud to, in a seamless manner, access and use, from the other cloud itself, a service provided by cloud A 1610. For example, MEI 1622 enables a user %178-1 associated with customer B1 1616-1 of cloud %170 to access a service from services A 1617 provided by cloud A 1610 in a seamless manner. In certain implementations, user interfaces (e.g., a console) may be provided that user %178-1 can access from within cloud B %170 that enable the user to see a list of services 1617 offered by cloud A 1610 and to select a particular service that the user %178-1 desires to access. In response to the user selection, MEI 1622 is responsible for performing processing that establishes link 1670 between clouds A and B to enable access to the requested service. The processing for setting up link 1670 is performed substantially automatically by MEI 1622. Customer B1 1616-1 or associated users %178-1 do not have worry about performing any system, networking, or other configuration changes that are needed to facilitate the creation, maintenance, and usage of link 1670 between clouds A 1610 and B %170. No burden is placed on the users or the customers in the creation of the link between the clouds. The link can be created in a fast and efficient manner.

MEI 1622 may use various techniques to make the creation and use of the link seamless to users and customers and thus provide for an enhanced user experience. In certain implementations, MEI 1622 causes the user interfaces (e.g., graphical user interfaces GUIs, etc.) and process flows that a customer B1 and associated users %178-1 interact with, such as for requesting a service from cloud A 1610 and for accessing the requested service from cloud A 1610, to be substantially similar to the interfaces and process flows that the customer/user would experience in cloud B %170. In this manner, the customer or user, who may be accustomed to the interfaces and process flows of cloud B %170, does not have to learn new interfaces and process flows to access a service 1617 from cloud A 1610. MEI 1622 may present different interfaces and process flows for users of different cloud environments. For example, a first set of user interfaces and process flows that are substantially similar to the user interfaces and flows of cloud B may be presented to a user from cloud B %170, while a different set of user interfaces and process flows that are substantially similar to the user interfaces and flows of cloud C may be presented to a user accessing cloud A 1610 from cloud C 1660. This is done to simplify and consequently enhance a user's experience for accessing services 1617 of cloud A 1610 from other clouds.

As another example, each cloud environment typically includes an identify management system that is configured to provide security for the cloud environment. The identity management system is configured to protect resources in the cloud environment, including resources provided by the CSP and resources of subscribing cloud customers that are deployed in the cloud environment. Functions performed by the identity management system include, for example, managing identity credentials (e.g., usernames, passwords, etc.) associated with the cloud's subscribing customers and associated users, using the identity credentials to regulate users'access to cloud resources and services based upon permission/access policies configured for the cloud environment, and other functions. Different clouds may use different identity management systems and associated techniques. For example, the identity management system and associated procedures in cloud A 1610 may be completely different from the identity management system and associated procedures in cloud B %170, which in turn may be completely different from the identity management system and associated procedures in cloud C 1660. In certain implementations, in spite of these differences in identity management systems and associated procedures between different cloud environments, a user associated with a customer of a first cloud can access a cloud service provided by a different cloud using the same identity credentials associated with the customer and the user in the first cloud.

For example, in the embodiment depicted in FIG. 16, cloud B %170 provided by CSP B may include an identity management system that assigns or allocates identity credentials to its subscribing customers and associated users, such as customer B1 1616-1 and associated users %178-1. These identity credentials are associated with the tenancy created for customer B1 1616-1 in cloud B %170. In certain implementations, MEI 1622 provided by cloud A 1610 enables a user %178-1 associated with cloud B customer B1 1616-1 to access a service from services A 1617 in cloud A 1610 using identity credentials associated with users %178-1 and customer B1 1616-1 in cloud B %170. This greatly enhances the user experience for users %178-1 since they do not have to create new identity credentials that are specific to cloud A 1610 just for the purpose of accessing a service 1617 in cloud A 1610. The MEI 1622 facilitates such access.

As an example, a customer B1 of cloud B %170 may select to use a service, such as a Database-as-a Service (DBaaS), from the set of services 1617 provided by cloud A 1610. In response to such a selection, MEI 1622 causes a link 1670 to be automatically created between cloud A 1610 and cloud B %170 to enable users %178-1 associated with customer B1 1616-1 to use the DBaaS service provided by cloud A 1610. The automatic setup of link 1670 is facilitated by MEI 1622. After link 1670 has been set up, a user %178-1 can use the DBaaS service in cloud A 1610 via cloud B %170. As part of using this service, user %178-1 can, via cloud B %170 send a request to cloud A 1610 to create a database resource. In response, CSPI_A 1612 may create the requested database in cloud A 1610. In certain implementations, the created database may be provisioned in a virtual network (e.g., a virtual cloud network or VCN) created for customer B1 in cloud A 1610 and is accessible to user %178-1 via cloud B %170. User %178-1 may then send, from cloud B %170, requests to cloud A 1610 to use the provisioned database. These requests may include, for example, requests to write data to the database, to update data stored in the database, to delete data in the database, to delete the database, to create additional databases, and the like. In some use cases, these requests may originate from a user %178-1 via cloud B %170 or from a service %174 provided by cloud B %170. In this manner, MEI 1622 provided by cloud A 1610 enables a user associated with a customer of a different cloud provided by a different CSP to seamlessly access a service provided by cloud A 1610.

Distributed environment 1600 depicted in FIG. 16 is merely an example and is not intended to unduly limit the scope of claimed embodiments. Many variations, alternatives, and modifications are possible. For example, in alternative embodiments, distributed environment 1600 may have more or fewer cloud environments. The cloud environments may also have more or fewer systems and components or may have a different configuration or arrangement of the systems and components. The systems and components depicted in FIG. 16 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

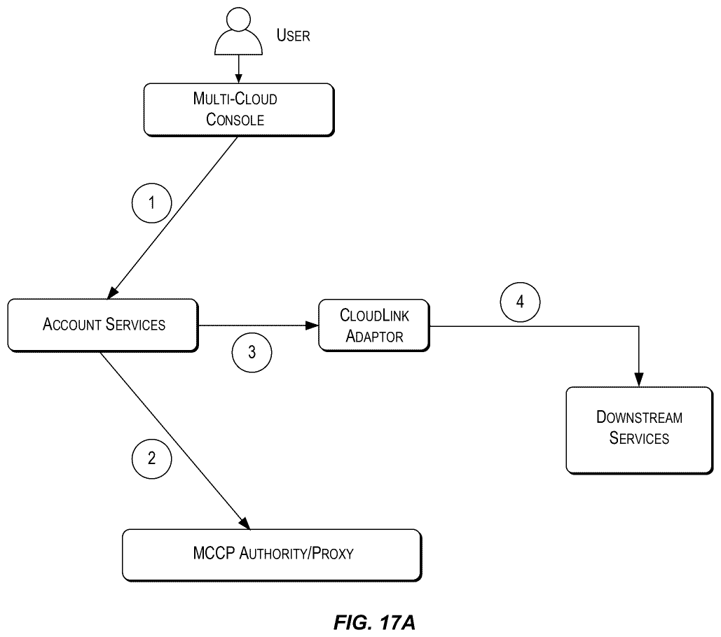

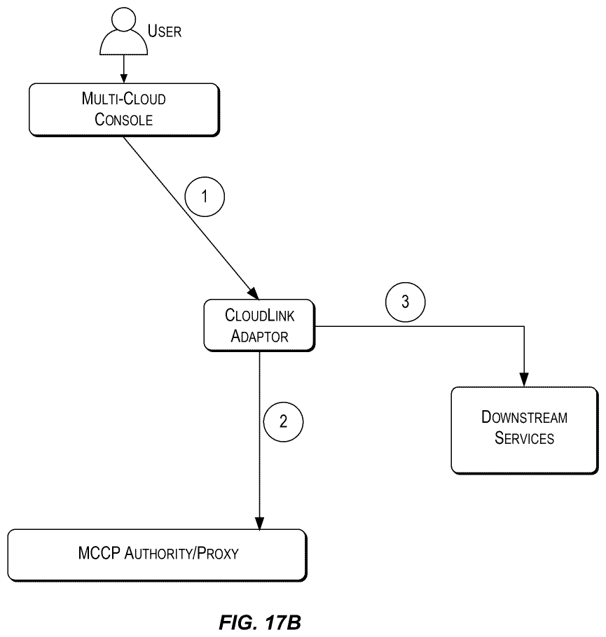

FIGS. 17A and 17B depict exemplary flow diagrams for linking two user accounts in different cloud environments, according to some embodiments. The two user accounts may correspond to a first user account (e.g., tenancy) in a first cloud infrastructure and a second user account in a second cloud infrastructure. FIG. 17A depicts the process of linking the two user accounts, wherein the tenancy of the user is initially created in the first cloud infrastructure and then linked to the account of the user in the second cloud infrastructure. FIG. 17B depicts the process of linking the two user accounts, wherein the tenancy of the user in the first cloud infrastructure is already created i.e., the tenancy already exists.

FIG. 17A depicts a data flow that is executed when a user representing a customer, such as a system administrator makes a call from the second cloud infrastructure to the multi-cloud infrastructure (included in the first cloud infrastructure) for signing up for services provided in the first cloud infrastructure. A special console (referred to herein as a multi-cloud console) may be provided for users of the second cloud infrastructure to open accounts within the first cloud infrastructure and to link the account of the user in the first cloud infrastructure to the account of the user in the second cloud infrastructure. It is noted that linking the accounts in the first and second cloud infrastructures, enables the user to utilize (from the second cloud infrastructure), one or more services provided by the first cloud infrastructure. In certain implementations, the user signs up for the services using the multi-cloud console. In response to the sign-up, a URL may be sent to the user that enables the user to log into the multi-cloud console. The multi-cloud console exposes UIs and APIs that are similar to the UIs and APIs of the second cloud infrastructure.

The multi-cloud console may provide various UIs (e.g., GUIs) that provide user-selectable options that enable a user of the second cloud infrastructure to open an account in the first cloud infrastructure and to further link the user accounts in the first and second cloud infrastructures. For example, multi-cloud console may provide a sign-up UI, which enables a user to create an account/tenancy in the first cloud infrastructure and to link the user's account (in the first cloud infrastructure) to the user's account in the second cloud infrastructure. Once the processing triggered responsive to the signup/link request is complete the user's accounts in the respective cloud infrastructures are linked together. As part of the processing, the multi-cloud console enables a user (e.g., a system administrator) to log into the second cloud infrastructure, and request: (a) creation of an account for the user (in the first cloud infrastructure) and to link the user's accounts; or (b) for an account that the user already has in the first cloud infrastructure, to request the user's first cloud infrastructure account to be linked to the user's second cloud infrastructure account.

Accordingly, in certain use cases, there are two possibilities: (a) the user already has an existing account or tenancy in the first cloud infrastructure and now, via the multi-cloud console sign-up UI, the user requests a link to be created between the user's accounts (details pertaining to this processing is described next with reference to FIG. 17B), or (b) the user requests both the creation of a new account in the first cloud infrastructure and the linking of the newly created account with the user's account in the second cloud infrastructure. Details pertaining to this processing is described next with reference to FIG. 17A. It is appreciated that linking of the accounts enables a user to, via the second cloud, use resources in the first cloud. For example, via the second cloud, a user can request a resource to be created or provisioned in the first cloud, utilize and manage resources in the first cloud, delete resources in the first cloud, and the like.

As shown in FIG. 17A, in step 1, in response to a user's input provided to multi-cloud console (e.g., sign-up UI of the multi-cloud console) requesting a new account for the user to be created in the first cloud infrastructure and linked to the user's account in the second cloud infrastructure, a call is made by the multi-cloud console to accounts services (in the first cloud infrastructure) to create a new account. It is noted that the call includes a token that is generated by second cloud infrastructure. The token generated by the second cloud infrastructure and included in the call to the accounts services enables the account or tenancy created in the first cloud infrastructure to be linked to the user's account in the second cloud infrastructure.

At step 2, as part of the processing for setting up the new account for the user, accounts service may make a call to the authority/proxy module included in the multi-cloud control plane to validate the token. The authority/proxy module validates the token and further processing may continue only upon successful validation of the token. Upon successful validation of the token, accounts service creates a new account for the user in the first cloud infrastructure. As part of creating the new account, a native user may be created and associated with the newly created account. However, note that this native user's credentials are not used. Rather, the user's identity in the second cloud infrastructure is used for managing the account and its resources (from the second cloud infrastructure) in the first cloud infrastructure.

After the new account has been successfully created by accounts services in the first cloud infrastructure, at step 3, accounts services makes a call to the cloud-link adaptor (included in the multi-cloud infrastructure) to create a link (also referred to as a cloud-link) between the user's account in the second cloud infrastructure and the newly created account in the first cloud infrastructure. In certain implementations, the cloud-link adaptor exposes APIs to account services and to multi-cloud console. These APIs may be called by account services (or by the multi-cloud console) to request linking of the accounts. It is noted that in some implementations, there is no token included in the call of step 3, since the call requesting the linkage is not made by the user but is rather initiated by accounts services. In this case, cloud-link adaptor does not do another authentication that would require another token because it relies upon accounts services having already performed the necessary authentication for the user as part of the processing for setting up the account using the token received in step 1.

In some implementations, the processing performed in step 3 by the cloud-link adaptor for linking the two accounts comprises:
(a) cloud-link adaptor creates a data object (also referred to herein as a cloud-link resource object for storing metadata information identifying the two accounts being linked. For example, the data object stores metadata information including a mapping of a first identifier associated with the tenancy (i.e., account) created in the first cloud infrastructure and a second identifier associated with the account of the user with the second cloud service provider.
(b) cloud-link adaptor creates a new compartment for storing and containing resources on the first cloud infrastructure side that the user can/would manage using the multi-cloud console. In some implementations, the cloud-link resource object is created at the root of the customer's account in the first cloud infrastructure.
(c) cloud-link adaptor creates a new resource-principal (referred to herein as a cloud-link resource principal) for a resource that is desired to be used by the user of the second cloud infrastructure.
(d) cloud-link adaptor may perform one or more federation setups that facilitate linking of a domain in the first cloud infrastructure to an active directory. The process of federating accounts of the first cloud infrastructure and the second cloud infrastructure allows users/groups of users in the second cloud infrastructure to be authenticated in first cloud infrastructure, and users/groups from the first cloud infrastructure to be authenticated into the second cloud infrastructure.

In certain implementations, permissions are associated with the cloud-link resource principal based upon the user's credentials/token in the account of the second cloud infrastructure. Consent for setting up the resource principal is provided by the user when the user requests a new account using the multi-cloud console or requests the user's account in the first cloud infrastructure to be linked to the user's account in the second cloud infrastructure. Further, as shown in step 4, the cloud-link resource principal is transmitted to the downstream service to enable the user to utilize the downstream service(s) (e.g., one or more services provided by the first cloud infrastructure) from the second cloud infrastructure.

Turning to FIG. 17B, there is depicted processing related to linking an existing account or tenancy in the first cloud infrastructure to an account of the user in the second cloud infrastructure. As shown in FIG. 17B, the user, via the sign-up UI provided by the multi-cloud console, requests the user's accounts in the first cloud infrastructure and the second cloud infrastructure to be linked. In response, in step 1, the multi-cloud console makes a call to the cloud-link adaptor to link the accounts. Such a call may be made using one of the APIs exposed by the cloud-link adaptor to the sign-up UI. In certain implementations, the information passed to the cloud-link adaptor in step 1, includes information identifying the user's account in the second cloud infrastructure and also the user's account in the first cloud infrastructure, a token issued by the second cloud infrastructure, etc.

At step 2, the cloud-link adaptor makes a call to the authority/proxy module included in the multi-cloud infrastructure to authenticate the token received in step 1. As part of this authentication, the authority/proxy module determines whether the user making the request has sufficient authority on the second cloud infrastructure side to make the linkage request. As part of the validation, roles and permissions set up on the second cloud infrastructure side may be checked. In response to the user being successfully validated, the cloud-link adaptor retrieves from the data object previously created for the user, the resource-principal associated with a resource that is desired to be utilized by the user. Further, as shown in step 3, the cloud-link resource principal is transmitted to the downstream service to enable the user to utilize the downstream service(s) (e.g., one or more services provided by the first cloud infrastructure) from the second cloud infrastructure.

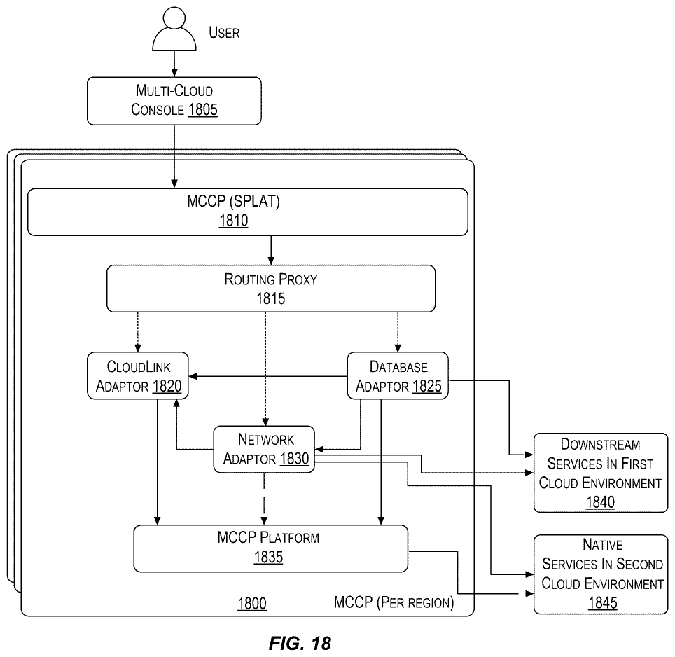

FIG. 18 depicts an exemplary system diagram illustrating components of a multi-cloud control plane (MCCP) according to some embodiments. The MCCP 1800 includes a service platform (SPLAT) 1810, a routing proxy 1815, a cloud-link adaptor 1820, a database adaptor 1825, a network adaptor 1830, and an MCCP platform 1835. Upon the user successfully completing the sign-up process as described above with reference to FIGS. 17A and 17B, the user may utilize the multi-cloud console 1805 to issue commands to access, create, or update a resource in the tenancy of the user in the first cloud infrastructure. For sake of illustration, in what follows, there is described a scenario of the user utilizing the multi-cloud console to issue a request to create an Exa-database resource.

In some implementations, the user accesses the multi-cloud console 1805 and provides login information e.g., credentials of the user in the second cloud infrastructure. The multi-cloud console 1805 provides a plurality of options e.g., create a resource, access a resource, update a resource etc. Such options may be provided to the user in the form of selectable icons (e.g., buttons) in the multi-cloud console 1805. Upon the user performing a selection (e.g., to create a resource), an API call is triggered to the service platform 1810. It is appreciated that the request made to the service platform 1810 is not a native call with respect to the first cloud infrastructure. Rather, the call is a REST type call including an authorization header that comprises a token associated with the user in the second cloud infrastructure.

The REST call including the token is further forwarded to the routing proxy module 1815 that performs authentication and access control operations. According to some embodiments, the routing proxy module 1815 performs an authentication operation by extracting the token included in the REST call. The routing proxy module 1815 validates the token by comparing a signature (used to sign the request) with a publicly available signature of the second cloud infrastructure to ensure that the request originates from a valid customer associated with the second cloud infrastructure. Additionally, the routing proxy module 1815 may also check roles i.e., privileges associated with the token e.g., whether the role corresponds to an Exadata DB administrator or the like. Based on the role, the routing proxy module 1815 may route the request to an appropriate adaptor included in the MCCP framework 1800.

According to one embodiment, the routing proxy module 1815 compares the role (associated with the token) to a preconfigured list of roles that is published and assigned (as part of the API specification) for each of the adaptors. For example, if the role associated with the token corresponds to an ‘Exadata DB administrator’, then the request may be comprehended as one being of creating an Exa-database and thus the request is forwarded to the database adaptor 1825. Additionally, by some embodiments, the routing proxy module 1815 may analyze information included in the REST call such as a provider ID, resource type requested, etc., and based on the analyzed information, the routing proxy module 1815 may forward the request to the appropriate adaptor.

In some implementations, the request obtained by the routing proxy module 1815 may not include information identifying the tenancy of the user in the first cloud infrastructure where the resource is to be deployed. Thus, the routing proxy module 1815 communicates with the cloud-link adaptor 1820 to obtain mapping information of the user's account in the second cloud infrastructure to the tenancy of the user in the first cloud infrastructure. If the mapping information exists, then the routing proxy module 1815 obtains the information pertaining to the tenancy of the user in the first cloud infrastructure and passes the information to the database adaptor 1825. In this manner, the database adaptor 1825 is aware of the tenancy of the user in the first cloud infrastructure where the resource is to be created/deployed. However, if the cloud-link adaptor 1820 determines that no mapping information exists, then the routing proxy module 1815 may simply issue, as a response to the request to create the database resource, an ‘unauthorized-access’ message that is transmitted back to the user.

It is noted that in some implementations, the cloud-link adaptor 1820 creates a data object (referred to herein as a cloud-link resource object) for storing metadata information identifying the two accounts being linked. For example, the data object stores metadata information including a mapping of a first identifier associated with the tenancy (i.e., account) in the first cloud infrastructure and a second identifier associated with the account of the user with the second cloud service provider. Additionally, the cloud-link adaptor 1820 also creates a resource-principal (referred to herein as a cloud-link resource principal) for a resource (e.g., database) that is desired to be created/managed by the user of the second cloud infrastructure. The cloud-link adaptor 1820 may maintain the data object as well as the resource-principal within a root compartment of the tenancy of the user in the first cloud infrastructure. In some embodiments, the cloud-link adaptor 1820 may also locally persist the data object and/or the resource principal in the MCCP platform 1835.

In some embodiments, the database adaptor 1825 may communicate with (or instruct) the network adaptor 1830 to create a network link between the user's account in the second cloud infrastructure and the tenancy of the user in the first cloud infrastructure. For instance, the network adaptor 1830 may obtain from the native services in the second cloud infrastructure module 1845, a token associated with the user and create: (1) a first peering relationship (in the first cloud environment) between a data plane of the MCCP and the tenancy of the user in the first cloud infrastructure, and (2) a second peering relationship (in the second cloud environment) between the user's account and a subscription of the first cloud provider included in the second cloud infrastructure.

The network adaptor 1830 is also configured to establish network connectivity between the first cloud infrastructure and the second cloud infrastructure i.e., the network adaptor 1830 can configure an interconnect that communicatively couples the two cloud environments. It is appreciated that upon forming the network link between the tenancy of the user in the first cloud infrastructure and the account of the user in the second cloud infrastructure, applications that are executed in the user's subscription/account are able to access resources e.g., Exa-database deployed in the tenancy of the first cloud infrastructure. Furthermore, the creation of the peering relationships provisions for metrics e.g., database usage metrics to be accessible in the second cloud infrastructure e.g., in a dashboard application that is executed in the subscription of the user in the second cloud infrastructure.

In some implementations, the database adaptor 1825 may obtain the resource principal that is locally persisted in the MCCP platform 1835. The database adaptor 1825 may transmit a request (including the resource-principal) to one or more downstream services included in the first cloud infrastructure 1840 to create the resources in the tenancy of the user in the first cloud infrastructure. In other words, the downstream services included in the first cloud infrastructure 1840 utilizes the identity i.e., resource principal obtained from the MCCP platform 1835 to create/deploy the required resources e.g., Exa-database in the tenancy of the user in the first cloud infrastructure. Upon the user issuing the request to create the Exa-database, the user may intermittently poll the MCCP 1800 to obtain a status of the request. Upon the downstream services of the first cloud infrastructure 1840 creating the resource in the tenancy of the user in the first cloud infrastructure, and the network adaptor 1830 establishing the peering relationships, the MCCP 1800 may notify the user regarding a successful completion of the request.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, by a second cloud environment from a first cloud environment, a request to perform an operation in the second cloud environment, the request comprising a first identifier and a URL, wherein the first cloud environment is provided by a first cloud service provider (CSP) and used to provide a first set of cloud services to one or more customers of the first CSP, and wherein the second cloud environment is provided by a second CSP different from the first CSP and is used to provide a second set of cloud services to one or more customers of the second CSP;
outputting, by the second cloud environment, a network request to a network location identified by the URL;
responsive to the outputting, receiving, by the second cloud environment and from the first cloud environment, a response to the network request comprising a second identifier;
comparing, by the second cloud environment, the second identifier to the first identifier;
upon determining, based upon the comparing, that the second identifier matches the first identifier, performing processing by the second cloud environment to enable performance of the operation; and
upon determining, based upon the comparing, that the second identifier does not match the first identifier, rejecting the request to perform the operation in the second cloud environment.

2. The method of claim 1, wherein the operation involves a service manager for a cloud service offered by the second cloud environment.

3. The method of claim 2, wherein the cloud service is a managed database service.

4. The method of claim 2, wherein:
the request is output by a first control plane for the first cloud environment in response to a command to access the service manager for the cloud service from a compute instance in a private virtual network in the first cloud environment; and
the request is received by a second control plane for the second cloud environment configured to authorize access to the service manager for the cloud service by the compute instance.

5. The method of claim 1, wherein the URL is cryptographically signed by the first CSP.

6. The method of claim 1, further comprising:
storing the URL and the second identifier in a cache; and
prior to outputting the network request to the network location identified by the URL, querying the cache to determine if the URL is stored in the cache.

7. The method of claim 6, wherein the URL has an associated expiration time after which a cache entry associated with the URL is invalid.

8. The method of claim 1, wherein the request further comprises additional identifiers of a user associated with the first cloud environment and the second cloud environment.

9. The method of claim 8, further comprising:
determining identity information about the user based on the first identifier;
validating at least one additional identifier of the additional identifiers using the identity information; and
responsive to validating the at least one additional identifier, generating a security token for accessing a service manager for a cloud service offered by the second cloud environment.

10. The method of claim 9, wherein the security token is a Resource Principal Session Token (“RPST”).

11. The method of claim 9, wherein the identity information about the user based on the first identifier is linkage information for a first customer associated with both the first cloud environment and the second cloud environment.

12. The method of claim 8, wherein:
a portion of the request including the first identifier, the additional identifiers, and the URL are cryptographically signed using a private key of the first CSP; and
the method further comprises verifying the cryptographic signature associated with the portion using a public key of the first CSP that corresponds to the private key.

13. A non-transitory computer-readable storage medium storing processor-executable instructions configured to cause one or more processors to:
receive, by a second cloud environment from a first cloud environment, a request to perform an operation in the second cloud environment, the request comprising a first identifier and a URL, wherein the first cloud environment is provided by a first CSP used to provide a first set of cloud services to one or more customers of the first CSP, and wherein the second cloud environment is provided by a second CSP different from the first CSP and is used to provide a second set of cloud services to one or more customers of the second CSP;
output, by the second cloud environment, a network request to a network location identified by the URL;
responsive to the outputting, receive, by the second cloud environment and from the first cloud environment, a response to the network request comprising a second identifier;
compare, by the second cloud environment, the second identifier to the first identifier;
upon determining, based upon the comparing, that the second identifier matches the first identifier, perform processing by the second cloud environment to enable performance of the operation; and
upon determining, based upon the comparing, that the second identifier does not match the first identifier, reject the request to perform the operation in the second cloud environment.

14. The non-transitory computer-readable storage medium of claim 13, wherein the URL is cryptographically signed by the first CSP.

15. The non-transitory computer-readable storage medium of claim 13, wherein:
the non-transitory computer-readable storage medium comprises additional processor-executable instructions configured to cause the one or more processors to:
store the URL and the second identifier in a cache; and
prior to outputting the network request to the network location identified by the URL, query the cache to determine if the URL is stored in the cache; and
the URL has an associated expiration time after which a cache entry associated with the URL is invalid.

16. The non-transitory computer-readable storage medium of claim 13, wherein:
the request further comprises additional identifiers of a user associated with the first cloud environment and the second cloud environment;
a portion of the request including the first identifier, the additional identifiers, and the URL are cryptographically signed using a private key of the first CSP; and
the processor-executable instructions are further configured to cause the one or more processors to verify the cryptographic signature associated with the portion using a public key of the first CSP that corresponds to the private key.

17. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive, by a second cloud environment from a first cloud environment, a request to perform an operation in the second cloud environment, the request comprising a first identifier and a URL, wherein the first cloud environment is provided by a first CSP and used to provide a first set of cloud services to one or more customers of the first CSP, and wherein the second cloud environment is provided by a second CSP different from the first CSP and is used to provide a second set of cloud services to one or more customers of the second CSP;
output, by the second cloud environment, a network request to a network location identified by the URL;
responsive to the outputting, receive, by the second cloud environment and from the first cloud environment, a response to the network request comprising a second identifier;
compare, by the second cloud environment, the second identifier to the first identifier;
upon determining, based upon the comparing, that the second identifier matches the first identifier, perform processing by the second cloud environment to enable performance of the operation; and
upon determining, based upon the comparing, that the second identifier does not match the first identifier, reject the request to perform the operation in the second cloud environment.

18. The system of claim 17, wherein the URL is cryptographically signed by the first CSP.

19. The system of claim 17, wherein:
the one or more processors are further configured to execute additional processor-executable instructions stored in the non-transitory computer-readable media to:
store the URL and the second identifier in a cache; and
prior to outputting the network request to the network location identified by the URL, query the cache to determine if the URL is stored in the cache; and
the URL has an associated expiration time after which a cache entry associated with the URL is invalid.

20. The system of claim 17, wherein:
the request further comprises additional identifiers of a user associated with the first cloud environment and the second cloud environment;
a portion of the request including the first identifier, the additional identifiers, and the URL are cryptographically signed using a private key of the first CSP; and
the one or more processors are further configured to execute additional processor-executable instructions stored in the non-transitory computer-readable media to verify the cryptographic signature associated with the portion using a public key of the first CSP that corresponds to the private key.
